(19) United States
(12) Patent Application Publication
(10) Pub. No.: US 2026/0075257 A1
(43) Pub. Date: Mar. 12, 2026

(54) DECODING METHOD, ENCODING METHOD, TRAINING METHOD, DECODER, AND ENCODER

(71) Applicant: GUANGDONG OPPO MOBILE TELECOMMUNICATIONS CORP., LTD., Dongguan (CN)

(72) Inventors: Hui YUAN, Dongguan (CN); Ming LI, Dongguan (CN); Dan ZOU, Dongguan (CN)

(21) Appl. No.: 19/391,034

(22) Filed: Nov. 17, 2025

Related U.S. Application Data
(63) Continuation of application No. PCT/CN2023/095934, filed on May 24, 2023.

(51) Int. Cl. H04N 19/86; H04N 19/105; H04N 19/137; H04N 19/176

(52) U.S. Cl. CPC H04N 19/86; H04N 19/105; H04N 19/137; H04N 19/176

(57) ABSTRACT

Embodiments of the present disclosure provide a decoding method, which includes: decoding a bitstream to determine a motion parameter of a current block; determining a reference block of the current block in a reference picture of the current block based on the motion parameter, performing quality enhancement on the reference block to obtain an enhancement block; and determining a prediction block of the current block based on the enhancement block.

### CROSS-REFERENCE TO RELATED APPLICATION

This application is a Continuation Application of International Application No. PCT/CN2023/095934 filed on May 24, 2023, which is incorporated herein by reference in its entirety.

### TECHNICAL FIELD

The embodiments of the present disclosure relate to the field of coding and decoding technologies, and in particular, to a decoding method, an encoding method, a training method, a decoder, and an encoder.

### RELATED ART

The digital video technology can be incorporated into a variety of video apparatuses, such as digital televisions, smartphones, computers, e-readers, or video players. With the development of video technology, video data includes a large amount of data. In order to facilitate the transmission of video data, the video apparatus adopts the video compression technology to achieve more efficient transmission or storage of video data.

There is temporal or spatial redundancy in the video, and prediction may be used to eliminate or reduce the redundancy in the video and improve the compression efficiency. In order to improve the prediction effect, an interpolation filtering prediction method is usually used for prediction compression. However, a current interpolation filtering prediction method has the problem of low prediction efficiency, resulting in poor video coding and decoding performance.

### SUMMARY

The embodiments of the present disclosure provide a decoding method, an encoding method, a training method, a decoder, and an encoder.

In a first aspect, embodiments of the present disclosure provide a decoding method, including:
decoding a bitstream to determine a motion parameter of a current block;
determining a reference block of the current block in a reference picture of the current block based on the motion parameter of the current block;
performing quality enhancement on the reference block to obtain an enhancement block; and
determining a prediction block of the current block based on the enhancement block.

In a second aspect, embodiments of the present disclosure provide an encoding method, including:
performing motion estimation on a current block to obtain a reference block of the current block;
performing quality enhancement on the reference block to obtain an enhancement block; and
determining a prediction block of the current block based on the enhancement block.

In a third aspect, embodiments of the present disclosure provide a neural network training method, including:
encoding a sample video to obtain a bitstream;
decoding the bitstream to determine a prediction block of a current block; and
training the neural network based on a label of the current block and the prediction block.

In a fourth aspect, embodiments of the present disclosure provide a decoder, including:
a first determining unit configured to decode a bitstream to determine a motion parameter of a current block;
a second determining unit configured to determine a reference block of the current block in a reference picture of the current block based on the motion parameter of the current block;
an enhancement unit configured to perform quality enhancement on the reference block to obtain an enhancement block; and
a third determining unit configured to determine a prediction block of the current block based on the enhancement block.

In a fifth aspect, embodiments of the present disclosure provide an encoder, including:
a first determining unit configured to perform motion estimation on a current block to obtain a reference block of the current block;
an enhancement unit configured to perform quality enhancement on the reference block to obtain an enhancement block; and
a second determining unit configured to determine a prediction block of the current block based on the enhancement block.

In a sixth aspect, embodiments of the present disclosure provide a neural network training apparatus, including:
an encoding unit configured to encode a sample video to obtain a bitstream;
a decoding unit configured to decode the bitstream to determine a prediction block of a current block; and
a training unit configured to train the neural network based on a label of the current block and the prediction block.

In a seventh aspect, embodiments of the present disclosure provide a decoder, including:
a processor adapted to implement computer instructions; and
a non-transitory computer-readable storage medium having stored computer instructions therein, where the computer instructions are suitable for being loaded by the processor to perform the decoding method involved in the above first aspect or various implementations thereof.

In an implementation, there are one or more processors and one or more memories.

In an implementation, the non-transitory computer-readable storage medium may be integrated with the processor, or the non-transitory computer-readable storage medium may be arranged separately from the processor.

In an eighth aspect, embodiments of the present disclosure provide an encoder, including:
a processor adapted to implement computer instructions; and
a non-transitory computer-readable storage medium having stored computer instructions therein, where the computer instructions are suitable for being loaded by a processor to execute the encoding method involved in the above second aspect or various implementations thereof.

In an implementation, there are one or more processors and one or more memories.

In an implementation, the non-transitory computer-readable storage medium may be integrated with the processor, or the non-transitory computer-readable storage medium may be arranged separately from the processor.

In a ninth aspect, embodiments of the present disclosure provide a neural network training apparatus, including:
a processor adapted to implement computer instructions; and
a non-transitory computer-readable storage medium having stored computer instructions therein, where the computer instructions are suitable for being loaded by a processor to execute the training method involved in the above third aspect or various implementations thereof.

In an implementation, there are one or more processors and one or more memories.

In an implementation, the non-transitory computer-readable storage medium may be integrated with the processor, or the non-transitory computer-readable storage medium may be arranged separately from the processor.

In a tenth aspect, embodiments of the present disclosure provide a non-transitory computer-readable storage medium, and the non-transitory computer-readable storage medium has stored computer instructions therein. The computer instructions, when read and executed by a processor of a computer device, enable the computer device to perform the decoding method involved in the above first aspect, the encoding method involved in the above second aspect, or the training method involved in the above third aspect.

In an eleventh aspect, embodiments of the present disclosure provide a computer program product or a computer program, the computer program product or the computer program includes computer instructions, and the computer instructions are stored in a non-transitory computer-readable storage medium. A processor of a computer device reads the computer instructions from the non-transitory computer-readable storage medium, and the processor executes the computer instructions to enable the computer device to perform the decoding method involved in the above first aspect, the encoding method involved in the above second aspect, or the training method involved in the above third aspect.

In a twelfth aspect, embodiments of the present disclosure provide a bitstream, and the bitstream is the bitstream involved in the decoding method described in the above first aspect or the bitstream generated by the method described in the above second aspect.

### BRIEF DESCRIPTION OF THE DRAWINGS

FIG. 1 is a schematic block diagram of a video encoding and decoding system involved in embodiments of the present disclosure.

FIG. 2 is a schematic block diagram of a video encoder involved in embodiments of the present disclosure.

FIG. 3 is a schematic block diagram of a video decoder involved in embodiments of the present disclosure.

FIG. 4 is an example of a framework of versatile video coding (VVC)/H.266 involved in embodiments of the present disclosure.

FIG. 5 is an example of a reference block involved in embodiments of the present disclosure.

FIG. 6 is an example of motion compensation involved in embodiments of the present disclosure.

FIG. 7 is a schematic flowchart of a decoding method provided in embodiments of the present disclosure.

FIG. 8 is an example of an encoding process provided in embodiments of the present disclosure.

FIG. 9 is an example of a decoding process provided in embodiments of the present disclosure.

FIG. 10 is an example of a decoder performing interpolation filtering based on an enhancement block provided in embodiments of the present disclosure.

FIG. 11 is another example of a decoder performing interpolation filtering based on an enhancement block provided in embodiments of the present disclosure.

FIG. 12 is a schematic flowchart of an inter prediction process without introducing an enhancement block provided in embodiments of the present disclosure.

FIG. 13 is a schematic flowchart of an inter prediction process with an enhancement block provided in embodiments of the present disclosure.

FIG. 14 is a schematic structural diagram of a dense-residual variable-size convolutional neural network (Dense-RVCNN) provided in embodiments of the present disclosure.

FIG. 15 is a schematic structural diagram of a DenseNet structure in a Dense-RVCNN provided in embodiments of the present disclosure.

FIG. 16 is a schematic flowchart of an encoding method provided in embodiments of the present disclosure.

FIG. 17 is a schematic flowchart of a neural network training method provided in embodiments of the present disclosure.

FIG. 18 is an example of an input and label during training of a neural network provided in embodiments of the present disclosure.

FIG. 19 is a schematic block diagram of a decoder provided in embodiments of the present disclosure.

FIG. 20 is a schematic block diagram of an encoder provided in embodiments of the present disclosure.

FIG. 21 is a schematic block diagram of a neural network training apparatus provided in embodiments of the present disclosure.

FIG. 22 is a schematic block diagram of an electronic device provided in embodiments of the present disclosure.

### DETAILED DESCRIPTION

The solutions provided in the embodiments of the present disclosure may be applied to the field of digital video coding technologies.

For example, the field to which the solutions provided in the embodiments of the present disclosure may be applied includes but not limited to: the field of picture coding and decoding, the field of video coding and decoding, the field of hardware video coding and decoding, the field of dedicated circuit video coding and decoding, and the field of real-time video coding and decoding. In addition, the solutions provided in the embodiments of the present disclosure may be combined with an audio video coding standard (AVS), a second-generation AVS standard (AVS2), or a third-generation AVS standard (AVS3), which includes, for example, but not limited to: the H.264/audio video coding (AVC) standard, H.265/high efficiency video coding (HEVC) standard, or H.266/versatile video coding (VVC) standard. Moreover, the solutions provided in the embodiments of the present disclosure may be used to perform lossy compression on a picture, or may be used to perform lossless compression on a picture. The lossless compression may be visually lossless compression or mathematically lossless compression.

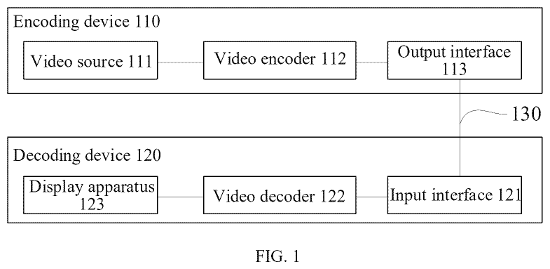

To facilitate the understanding, a video encoding and decoding system involved in embodiments of the present disclosure is first introduced with reference to FIG. 1.

FIG. 1 is a schematic block diagram of a video encoding and decoding system involved in embodiments of the present disclosure.

As shown in FIG. 1, the video encoding and decoding system 100 includes an encoding device 110 and a decoding device 120.

The encoding device 110 is used to encode (which may be understood as “compress”) video data to generate a bitstream, and transmit the bitstream to the decoding device 120. The decoding device 120 decodes the bitstream generated by the encoding device 110 to obtain decoded video data.

The encoding device 110 may be understood as a device with a video encoding function, and the decoding device 120 may be understood as a device with a video decoding function. That is, in the embodiments of the present disclosure, both the encoding device 110 and the decoding device 120 include a wide range of apparatuses, such as smartphones, desktop computers, mobile computing apparatuses, notebook (e.g., laptop) computers, tablet computers, set-top boxes, televisions, cameras, display apparatuses, digital media players, video game consoles, or in-vehicle computers.

The encoding device 110 may transmit the encoded video data (e.g., the bitstream) to the decoding device 120 via a channel 130.

The channel 130 may include one or more media and/or apparatuses capable of transmitting the encoded video data from the encoding device 110 to the decoding device 120.

The channel 130 may include one or more communication media that enable the encoding device 110 to transmit the encoded video data directly to the decoding device 120 in real time. The encoding device 110 may modulate the encoded video data based on a communication standard and transmit the modulated video data to the decoding device 120. The communication media include a wireless communication medium, such as a radio frequency spectrum. The communication media may also include a wired communication medium, such as one or more physical transmission lines.

The channel 130 may include a storage medium, and the storage medium may store the video data encoded by the encoding device 110. The storage media include various locally accessible data storage media, such as an optical disk, a digital video disk (DVD), and a flash memory. In this instance, the decoding device 120 may acquire the encoded video data from the storage medium.

The channel 130 may include a storage server, and the storage server may store the video data encoded by the encoding device 110. In this instance, the decoding device 120 may download the encoded video data stored in the storage server. Optionally, the storage server may store the encoded video data and transmit the encoded video data to the decoding device 120. For example, the storage server is a web server (e.g., for a website), a file transfer protocol (FTP) server, etc.

The encoding device 110 includes a video encoder 112 and an output interface 113.

The output interface 113 may include a modulator/demodulator (modem) and/or a transmitter. The video encoder 112 transmits the encoded video data directly to the decoding device 120 via the output interface 113. The encoded video data may also be stored in a storage medium or a storage server for subsequent reading by the decoding device 120.

The encoding device 110 may further include a video source 111 in addition to the video encoder 112 and an output interface 113.

The video source 111 may include at least one of a video capture apparatus (e.g., a video camera), a video archive, a video input interface, and a computer graphics system. The video input interface is used to receive video data from a video content provider. The computer graphics system is used to generate video data. The video encoder 112 encodes the video data from the video source 111 to generate a bitstream. The video data may include one or more pictures or a sequence of pictures. The bitstream contains encoding information of the picture(s) or sequence of pictures in the form of a bitstream. The encoding information may include encoded picture data and associated data. The associated data may include a sequence parameter set (SPS), a picture parameter set (PPS) and other syntax structures. The SPS may contain parameters applied to one or more sequences. The PPS may contain parameters applied to one or more pictures. The syntax structure refers to a set of zero or more syntax elements arranged in a specified order in the bitstream.

The decoding device 120 includes an input interface 121 and a video decoder 122. The input interface 121 may include a receiver and/or a modem.

The decoding device 120 may further include a display apparatus 123 in addition to the input interface 121 and the video decoder 122.

The input interface 121 may receive the encoded video data via the channel 130. The video decoder 122 is configured to decode the encoded video data to obtain the decoded video data, and transmit the decoded video data to the display apparatus 123. The display apparatus 123 displays the decoded video data. The display apparatus 123 may be integrated with the decoding device 120 or external to the decoding device 120. The display apparatus 123 may include one of various display apparatuses, such as a liquid crystal display (LCD), a plasma display, an organic light-emitting diode (OLED) display, or any of other types of display apparatuses.

It should be understood that FIG. 1 is only an example of the present disclosure and should not be understood as a limitation of the present disclosure. That is to say, the technical solutions in the embodiments of the present disclosure are not limited to the system framework shown in FIG. 1. For example, the technology in the present disclosure may also be applied to unilateral video encoding or unilateral video decoding.

The following is an introduction to a video encoding framework involved in embodiments of the present disclosure.

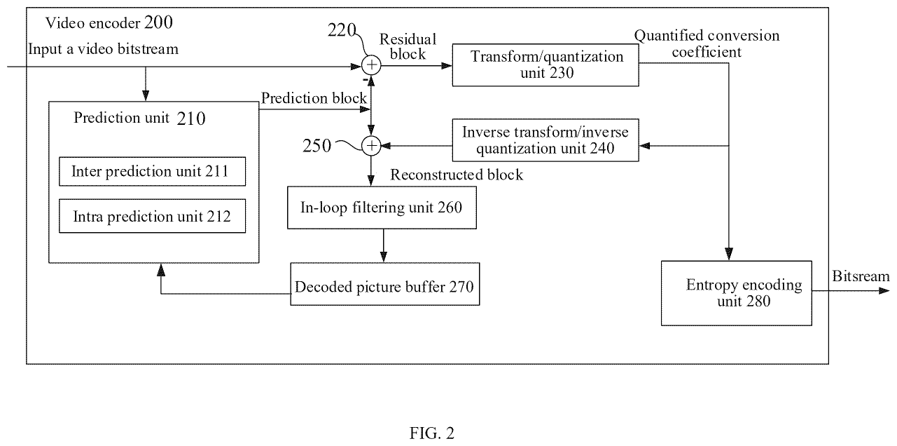

FIG. 2 is a schematic block diagram of a video encoder 200 involved in embodiments of the present disclosure.

It should be understood that the video encoder 200 may be applied to picture data in a luma and chroma (YCbCr, YUV) format. For example, a YUV ratio may be 4:2:0, 4:2:2, or 4:4:4, where Y represents luma, Cb (U) represents blue chroma, Cr (V) represents red chroma, and U and V represent chroma for describing color and saturation. For example, in a color format, 4:2:0 represents that every 4 samples have 4 luma components and 2 chroma components (YYYYCbCr), 4:2:2 represents that every 4 samples have 4 luma components and 4 chroma components (YYYYCbCrCbCr), and 4:4:4 represents full sample display (YYYYCbCrCbCrCbCrCbCr).

The video encoder 200 reads video data and partitions each picture of the video data into several coding tree units (CTUs). In some examples, the CTU may be referred to as a “tree block”, “largest coding unit (LCU)”, or “coding tree block (CTB)”. Each CTU may be associated with a sample block with identical size within the picture. Each sample may correspond to one luma (or luminance) sample and two chroma (or chrominance) samples. Therefore, each CTU may be associated with one luma sample block and two chroma sample blocks. A size of a single CTU is, for example, 128×128, 64×64, or 32×32. A single CTU may be further partitioned into several coding units (CUs) for encoding. The CU may be a rectangular block or a square block. The CU may be further partitioned into a prediction unit (PU) and a transform unit (TU), which makes encoding, prediction and transform separate, thereby making processing more flexible. In an example, a CTU is partitioned into CUs in a Quadtree manner, and a CU is partitioned into a TU and a PU in a Quadtree manner.

The video encoder and video decoder may support PUs with various sizes. Assuming that the size of a specific CU is 2N×2N, the video encoder and video decoder may support a PU with a size of 2N×2N or N×N for intra prediction, and support a symmetric PU of 2N×2N, 2N×N, N×2N, N×N or a similar size for inter prediction. The video encoder and video decoder may also support asymmetric PUs of 2N×nU, 2N×nD, nL×2N, and nR×2N for inter prediction.

As shown in FIG. 2, the video encoder 200 may include: a prediction unit 210, a residual unit 220, a transform/quantization unit 230, an inverse transform/inverse quantization unit 240, a reconstruction unit 250, an in-loop filtering unit 260, a decoded picture buffer 270, and an entropy encoding unit 280. It should be noted that the video encoder 200 may include more, fewer or different functional components. In the present disclosure, a current block may be referred to as a current coding unit (CU) or a current prediction unit (PU), a prediction block may be referred to as a prediction picture block or a picture prediction block, and a reconstructed picture block may be referred to as a reconstructed block or a picture reconstructed picture block.

The prediction unit 210 includes an inter prediction unit 211 and an intra prediction unit 212. Since there is a strong correlation between adjacent samples in a picture of a video, an intra prediction method is used in the video coding and decoding technologies to eliminate spatial redundancy between the adjacent samples. Since there is a strong similarity between adjacent pictures in a video, an inter prediction method is used in the video coding and decoding technologies to eliminate temporal redundancy between the adjacent pictures. Thus, the coding efficiency is improved.

The inter prediction unit 211 can be used for inter prediction. The inter prediction may include motion estimation and motion compensation, and may refer to picture information of different pictures. In the inter prediction, motion information is used to find a reference block from a reference picture, and a prediction block is generated based on the reference block to eliminate temporal redundancy. A picture used for the inter prediction may be a P picture and/or B picture, where the P picture refers to a predictive picture and the B picture refers to a bi-directionally predictive picture. The inter prediction uses the motion information to find the reference block from the reference picture, and generates the prediction block based on the reference block. The motion information includes a reference picture list where the reference picture is located, a reference picture index, and a motion vector. The motion vector may be an integer-pixel motion vector or a fractional-pixel motion vector. In the case where the motion vector is the fractional-pixel motion vector, interpolation filtering needs to be used in the reference picture to generate a required fractional-pixel block. Here, an integer-pixel block or fractional-pixel block found in the reference picture based on the motion vector is called the reference block. In some technologies, the reference block can be directly used as the prediction block. In some other technologies, the prediction block can be generated by processing the reference block. Processing the reference block to generate the prediction block can also be understood as taking the reference block as a prediction block and then processing the prediction block to generate a new prediction block.

The intra prediction unit 212 only refers to information of the same picture to predict sample information in a current picture block, so as to eliminate spatial redundancy. A picture used for the intra prediction may be an I picture.

There are multiple prediction modes for the intra prediction. Considering H series of international digital video coding standards as an example, the H.264/AVC standard has 8 angle prediction modes and 1 non-angle prediction mode, and the H.265/HEVC standard is expanded to 33 angle prediction modes and 2 non-angle prediction modes. Intra prediction modes used by HEVC include a planar mode (Planar), a direct current (DC) mode, and 33 angle modes, for a total of 35 prediction modes. Intra prediction modes used by VVC are a Planar, a DC mode, and 65 angle modes, for a total of 67 prediction modes. It should be noted that, with the increase of angle modes, intra prediction will be more accurate and more in line with the requirements of the development of high-definition and ultra-high-definition digital videos.

The residual unit 220 can generate a residual block of a CU based on a sample block of the CU and a prediction block of a PU of the CU. For example, the residual unit 220 may generate a residual block for a CU such that each sample in the residual block has a value equal to a difference between a sample in the sample block of the CU and a corresponding sample in a prediction block of a PU of the CU.

The transform/quantization unit 230 can quantize a transform coefficient. The transform/quantization unit 230 may quantize a transform coefficient associated with a TU of the CU based on a quantization parameter (QP) value associated with the CU. The video encoder 200 may adjust a degree of quantization applied to the transform coefficient associated with the CU by adjusting the QP value associated with the CU.

The inverse transform/inverse quantization unit 240 can separately perform inverse quantization and inverse transform on the quantized transform coefficient to reconstruct a residual block from the quantized transform coefficient.

The reconstruction unit 250 can add samples of the reconstructed residual block to corresponding samples of one or more prediction blocks generated by the prediction unit 210 to generate a reconstructed picture block associated with the TU. By reconstructing the sample block of each TU of the CU in this manner, the video encoder 200 may reconstruct the sample block of the CU.

The in-loop filtering unit 260 is used to process the inverse-transformed and inverse-quantized samples to compensate for distortion information and provide a good reference for subsequent encoded samples. For example, a deblocking filtering operation may be performed to reduce blocking artifacts of the sample block associated with the CU. In some embodiments, the in-loop filtering unit 260 includes a deblocking filtering unit and a sample adaptive offset/adaptive loop filtering (SAO/ALF) unit, where the deblocking filtering unit is used to remove blocking artifacts, and the SAO/ALF unit is used to remove a ringing effect.

The decoded picture buffer 270 can store the reconstructed sample block. The inter prediction unit 211 may use a reference picture containing the reconstructed sample block to perform inter prediction on a PU of another picture. In addition, the intra prediction unit 212 may use the reconstructed sample block in the decoded picture buffer 270 to perform intra prediction on other PUs in the same picture as the CU.

The entropy encoding unit 280 can receive the quantized transform coefficient from the transform/quantization unit 230. The entropy encoding unit 280 may perform one or more entropy encoding operations on the quantized transform coefficient to generate entropy-coded data.

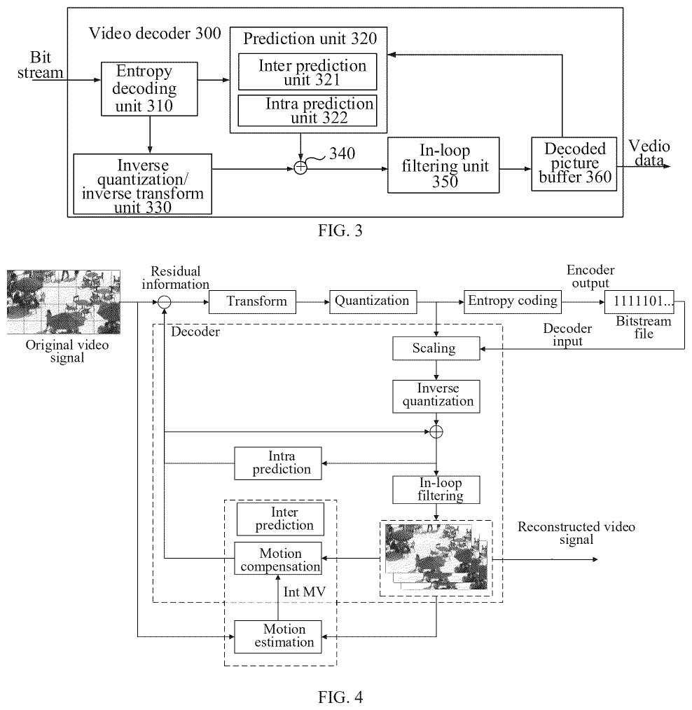

FIG. 3 is a schematic block diagram of a video decoder involved in embodiments of the present disclosure.

As shown in FIG. 3, the video decoder 300 includes: an entropy decoding unit 310, a prediction unit 320, an inverse quantization/inverse transform unit 330, a reconstruction unit 340, an in-loop filtering unit 350, and a decoded picture buffer 360. It should be noted that the video decoder 300 may include more, fewer or different functional components.

The video decoder 300 can receive a bitstream. The entropy decoding unit 310 can parse the bitstream to extract syntax element(s) from the bitstream. As part of parsing the bitstream, the entropy decoding unit 310 may parse entropy-coded syntax element(s) in the bitstream. The prediction unit 320, the inverse quantization/inverse transform unit 330, the reconstruction unit 340, and the in-loop filtering unit 350 may decode video data based on the syntax element(s) extracted from the bitstream, i.e., generate decoded video data.

The prediction unit 320 includes an intra prediction unit 322 and an inter prediction unit 321.

The intra prediction unit 322 can perform intra prediction to generate a prediction block for a PU. The intra prediction unit 322 may use an intra prediction mode to generate a prediction block of a PU based on sample blocks of spatially-adjacent PUs. The intra prediction unit 322 may also determine the intra prediction mode of the PU based on one or more syntax elements parsed from the bitstream.

The inter prediction unit 321 can construct a first reference picture list (List 0) and a second reference picture list (List 1) based on the syntax element(s) parsed from the bitstream. Furthermore, in a case where the PU is encoded by using inter prediction, the entropy decoding unit 310 may parse motion information of the PU. The inter prediction unit 321 may determine one or more reference blocks of the PU based on the motion information of the PU. The inter prediction unit 321 may generate a prediction block of the PU based on the one or more reference blocks of the PU.

The inverse quantization/inverse transform unit 330 can perform inverse quantization (i.e., de-quantization) on a transform coefficient associated with a TU. The inverse quantization/inverse transform unit 330 may use a QP value associated with a CU of the TU to determine a degree of quantization. After the transform coefficient is inverse-quantized, the inverse quantization/inverse transform unit 330 may apply one or more inverse transforms to the inverse-quantized transform coefficient to generate a residual block associated with the TU.

The reconstruction unit 340 uses the residual block associated with the TU of the CU and the prediction block of the PU of the CU to reconstruct a sample block of the CU. For example, the reconstruction unit 340 may add samples of the residual block to corresponding samples of the prediction block to reconstruct the sample block of the CU, so as to obtain a reconstructed picture block.

The in-loop filtering unit 350 can perform a deblocking filtering operation to reduce blocking artifacts of the sample block associated with the CU.

The video decoder 300 can store the reconstructed picture of the CU in the decoded picture buffer 360. The video decoder 300 can use the reconstructed picture in the decoded picture buffer 360 as a reference picture for subsequent prediction, or transmit the reconstructed picture to a display apparatus for display.

A basic process of video encoding and decoding is as follows. At an encoding end, a picture is partitioned into blocks, and for a current block, the prediction unit 210 generates a prediction block of the current block using intra prediction or inter prediction. The residual unit 220 may calculate, based on the prediction block and an original block of the current block, a residual block, i.e., a difference between the prediction block and the original block of the current block. The residual block may also be referred to as residual information. The residual block undergoes processes such as transform and quantization by the transform/quantization unit 230, so that information to which the human's eyes are not sensitive may be removed to eliminate visual redundancy. Optionally, the residual block before the transform and quantization performed by the transform/quantization unit 230 may be referred to as a time domain residual block, and the time domain residual block after the transform and quantization performed by the transform/quantization unit 230 may be referred to as a frequency residual block or a frequency domain residual block. The entropy encoding unit 280 receives the quantized transform coefficient output by the transform/quantization unit 230, performs entropy encoding on the quantized transform coefficient, and output a bitstream. For example, the entropy encoding unit 280 may eliminate character redundancy based on a target context model and probability information of the binary bitstream.

At a decoding end, the entropy decoding unit 310 can parse the bitstream to obtain prediction information, quantization coefficient matrix, etc. of the current block. The prediction unit 320 performs intra prediction or inter prediction on the current block to generate a prediction block of the current block based on the prediction information. The inverse quantization/inverse transform unit 330 uses the quantization coefficient matrix obtained from the bitstream to perform inverse quantization and inverse transform on the quantization coefficient matrix to obtain a residual block. The reconstruction unit 340 adds the prediction block and the residual block to obtain a reconstructed block. Reconstructed blocks constitute a reconstructed picture. The in-loop filtering unit 350 performs in-loop filtering on the reconstructed picture based on a picture or a block to obtain a decoded picture. The encoding end also needs to perform operations similar to those at the decoding end to obtain a decoded picture. The decoded picture may also be referred to as a reconstructed picture, and the reconstructed picture may be used as a reference picture of a subsequent picture for inter prediction.

It should be noted that, block partition information, as well as mode information or parameter information for prediction, transform, quantization, entropy encoding, in-loop filtering, etc., determined by the encoding end, are carried in the bitstream when necessary. The decoding end parses the bitstream, and performs analysis based on existing information to determine the same block partition information, and mode information or parameter information for prediction, transform, quantization, entropy encoding, in-loop filtering, etc. as those at the encoding end, thereby ensuring that the decoded picture obtained by the encoding end is the same as the decoded picture obtained by the decoding end. In addition, in the embodiments of the present disclosure, due to the requirements for parallel processing, a picture may be partitioned into slices, and the slices in the same picture may be processed in parallel, that is, there is no data dependency between the slices. The term “frame” is a commonly used term, which can generally be understood that a frame is a picture. The frame described in the present disclosure may also be replaced by a picture or slices.

It is worth noting that the above is the basic process of the video codec under a block-based hybrid coding framework. With the development of technology, some modules or steps of the framework or process may be optimized. The present disclosure is applicable to the basic process of the video codec under the block-based hybrid coding framework, but is not limited to the framework and the process.

FIG. 4 is an example of another coding framework involved in embodiments of the present disclosure.

As shown in FIG. 4, under this coding framework, the encoding and decoding process includes the following. First, at the encoder, an original video signal is partitioned into several picture blocks, each picture block is processed separately and then input into a prediction module. The prediction module mainly performs intra prediction and inter prediction. The intra prediction is performed to mainly predict a content of a current block based on a spatial relationship of the picture. The inter prediction is performed to predict the content of the current block based on a spatial and temporal relationship between consecutive pictures. By performing subtraction on the prediction picture (prediction block) and the original signal picture (original block), a residual picture (residual block) is obtained. Processes such as transform, quantization, and entropy encoding are performed on the residual block to further compress the video data, and finally a bitstream file of the video is output. The decoder may reconstruct a video signal based on the bitstream file output by the encoder. Most common video compression is lossy compression, which sacrifices picture quality appropriately in exchange for a high compression ratio. Therefore, the video signal reconstructed by the decoder is lossy compared to the original video.

The inter prediction is mainly used to eliminate temporal redundancy in the video signal.

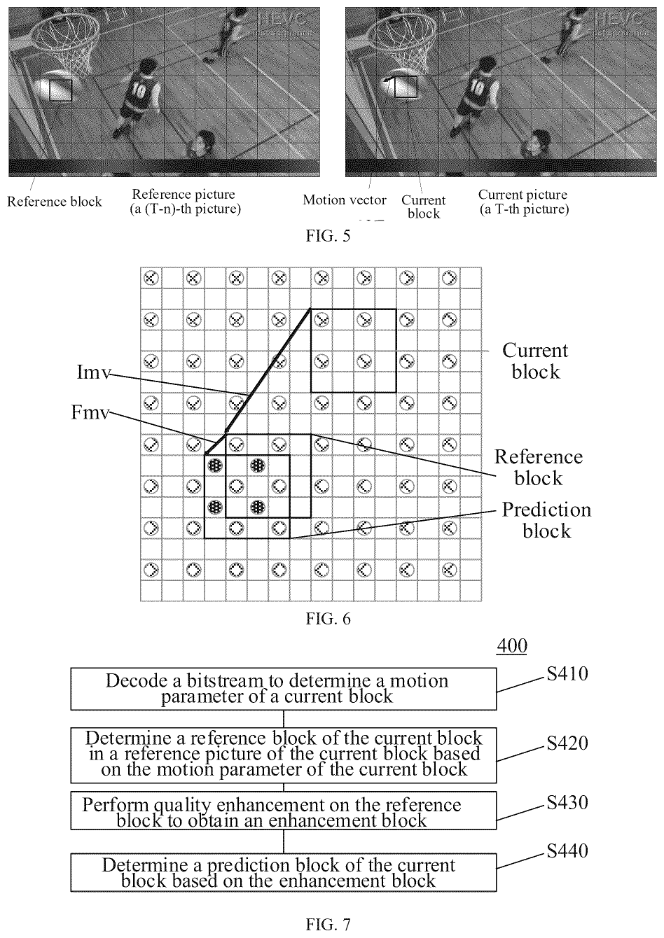

In the video signal, adjacent video pictures have a lot of similar content. As shown in FIG. 5, when a current block in a current picture (a T-th picture) is encoded, a picture block (a reference block) that is most similar to the current block may be found from a reconstructed reference picture (a (T−n)-th picture). Since the two picture blocks are very similar, only a difference between the two blocks and a motion vector (MV) between the two blocks need to be transmitted. Compared with direct transmission of picture information of the current block, the picture information that needs to be transmitted is greatly compressed in this method. The process of finding the reference block is referred to as motion estimation (ME). However, due to the inherent property of spatial discretization of the digital video, block translation may not be exactly aligned with samples.

FIG. 6 is an example of motion compensation involved in embodiments of the present disclosure.

As shown in FIG. 6, a block where a dot is located represents an integer-pixel position. A position of the reference block may usually be found for the current block based on the integer-pixel MV (Int MV, IMV), but this method is still not accurate enough. Optionally, interpolation may be performed on the reference block first, and then a picture at the fractional-pixel position may be selected to further improve the prediction accuracy. The fractional-pixel picture is referred to as a prediction block and its displacement is referred to as a fractional motion vector (FMV). A process of selecting an optimal prediction block based on the reference block is referred to as motion compensation (MC). How to derive a fractional-pixel picture from an integer-pixel picture, discrete cosine interpolation filters with different parameters in VVC are used to filter the integer-pixel picture. The prediction block obtained after filtering may be closer to the original block than the reference block.

It can be seen from the above that the quality of the reference block directly affects the coding quality of the current block. The closer the picture of the reference block is to the original block, the smaller the information of the residual block that needs to be transmitted is, and the lower the video bitstream is. In this direction, most research focuses on the optimization of interpolation filters, and an appropriate tap coefficient of the interpolation filter is used to generate a good prediction block.

With the development of the field of deep learning, many scholars use a network model generated by deep learning to derive or refine a picture of a prediction block. Mostly, a neural network model is used in inter prediction instead of interpolation filtering process to improve the accuracy of the prediction block. In an implementation, a neural network model including three layers of convolution may be provided, and different data sets may be generated using reference blocks corresponding to different fractional interpolation filters and original blocks to train the network model. Then, convolutional layer parameters in the network model are compressed into a matrix, and the matrix is used to replace the tap coefficient of the interpolation filter in H.266/VVC inter prediction. The method, in which a neural network model is used to directly replace the interpolation filtering process, has the following two disadvantages.
1. During inter prediction, the current block usually undergoes hundreds of interpolation filtering processes in order to find an optimal prediction value. Therefore, the neural network model is called each time, which will greatly increase the complexity of coding.
2. A network model is used to instead of an interpolation filter, but different network models cannot be used in combination.

In view of this, the present disclosure introduces a method for performing quality enhancement on a reference region of a reference picture to obtain an enhanced picture; In some implementations, an enhancement block corresponding to a position of a reference block is found in the enhanced picture to perform interpolation filtering, so as to obtain a prediction block. This technology only needs to enhance the quality of the picture when the reference region is reconstructed, which effectively reduces the complexity caused by calling the neural network and improves the picture quality of the reference region, thereby facilitating more accurate prediction. First, in the present disclosure, a data set is generated to train a proposed neural network; secondly, the neural network is integrated into the H.266/VVC framework to enhance the reconstructed reference region. For the same reference picture, different network parameters of the neural network are used to generate multiple enhanced pictures. Based on a minimum side length of a CU block, an enhancement block that matches the size of the CU block is determined in different enhanced pictures. The enhancement block is used instead of the reference block for subsequent operations such as motion compensation. Finally, the effectiveness of this method in improving video coding and decoding performance is verified through experiments.

Referring to FIG. 7, a decoding method provided in embodiments of the present disclosure is introduced below by taking a decoding end as an example.

FIG. 7 is a schematic flowchart of a decoding method 400 provided in embodiments of the present disclosure. It should be understood that the decoding method 400 can be performed by a decoder. For example, the decoding method 400 may be performed by the video decoder 122 shown in FIG. 1, or performed by the video decoder 300 shown in FIG. 3. For the convenience of description, the following description is made by taking the decoder as an example.

As shown in FIG. 7, the decoding method 400 may include the following.

In S410, the decoder decodes a bitstream to determine a motion vector (MV) of a current block.

For example, the decoder determines the MV of the current block by decoding the bitstream.

For example, the MV of the current block may include an MV with integer-pixel precision and an MV with fractional-pixel precision.

In S420, the decoder determines a reference block of the current block in a reference picture of the current block based on the motion parameter of the current block.

For example, the reference picture may be a decoded picture.

For example, the reference block may be a component reference block, e.g., a chroma component reference block or a luma component reference block.

In S430, the decoder performs quality enhancement on the reference block to obtain an enhancement block.

For example, the decoder performs quality enhancement on the reference block through a neural network, to obtain the enhancement block.

The neural network includes but is not limited to: a traditional learning model, an ensemble learning model, or a deep learning model. The traditional learning model includes but is not limited to: a tree model (a regression tree) or a logistic regression (LR) model; the ensemble learning model includes but is not limited to: an advanced model of gradient boosting algorithm (extreme gradient boosting, XGBoost) or a random forest model; the deep learning model includes but is not limited to: a deep neural network (DNN) model, a convolutional neural network (CNN) model, a recurrent neural network (RNN) model, a dynamic Bayesian network (DBN) model, or a stacked auto-encoder network (SAE) model. In other embodiments of the present disclosure, any other machine learning model or even a combination of multiple models may be used.

In other alternative embodiments, the decoder may perform quality enhancement on the reference block by other methods. For example, the decoder performs quality enhancement on the reference block based on information obtained by decoding the bitstream, and the present disclosure does not limit thereto.

In S440, the decoder determines a prediction block of the current block based on the enhancement block.

For example, the decoder may perform motion compensation on the enhancement block to obtain the prediction block.

The motion compensation includes but is not limited to the following two types.

Inter prediction filter: in order to alleviate discontinuity between a prediction sample and a neighboring sample, a filtering process is performed on each prediction value in the reference block. Filtering is achieved through weighted averaging. Inputs of a filter include the prediction sample and the neighboring sample, and a weight factor is determined based on a positional relationship between the samples.

Affine motion compensation (AMC): only translational motion is considered for the motion of an object, while there are more complex motion modes in real scenarios, such as rotation and scaling. In order to adapt to different motion modes, for the AMC, a CU is partitioned into different sub-blocks, and an MV is generated for each sub-block through an affine model. Affine models include a 4-parameter model (2 control point motion vectors (CPMVs)) and a 6-parameter model (3 CPMVs). After reference sub-blocks are determined based on MVs of the sub-blocks, prediction sub-blocks are obtained by performing interpolation filtering on the reference sub-blocks, and the prediction sub-blocks constitute the prediction block.

In the embodiments of the present disclosure, the decoder obtains the enhancement block by performing quality enhancement on the reference block, and then determines the prediction block of the current block based on the enhancement block, which is equivalent to converting a quality enhancement process for the prediction block into a quality enhancement process for the reference block by the decoder. Thus, it may be possible to prevent the quality enhancement process for the prediction block from being coupled to a determination process of the prediction block, which reduces the decoding complexity, and thereby improves the decoding performance.

The technical solution proposed in the present disclosure is implemented in a VVC test software VTM11.0_nnvc_2.0, and test sequences used are Class B, Class C, Class D and Class E sequences given in general test conditions. The results in Table 1 are obtained by encoding with QP settings of 22, 27, 32, and 37 in a low-delay-P (LDP) mode. Values in the table are represented by Bjontegaard delta rate (BD-rate), and the BD-rate is a way to measure algorithm performance. Compared with the original algorithm, for the algorithm in the solution provided in the present disclosure, changes in peak signal to noise ratio (PSNR) and structural similarity index measure (SSIM) are all negative values, indicating that the performance is improved, and the greater the absolute value, the greater the performance improvement.

TABLE 1

| Class | Sequence | Y D-rate(PSNR) | Y BD-rate(SSIM) |
|---|---|---|---|
| B | Cactus | −0.21% | −0.53% |
| | BasketballDrive | −1.65% | −2.54% |
| | BQTerrace | −0.28% | −0.30% |
| | Average | −0.71% | −1.12% |
| C | BasketballDrill | −0.50% | −0.71% |
| | BQMall | −1.20% | −1.43% |
| | PartyScene | −0.35% | −0.77% |
| | RaceHorses | −0.35% | −0.07% |
| | Average | −0.83% | −0.75% |
| D | BasketballPass | −1.32% | −1.29% |
| | BQSquare | −1.38% | −3.16% |
| | BlowingBubbles | −1.10% | −0.75% |
| | RaceHorses | −0.37% | −0.57% |
| | Average | −1.04% | −1.44% |
| E | FourPeople | −0.82% | −1.65% |
| | Johnny | −1.65% | −2.65% |
| | KristenAndSara | −0.05% | −0.71% |
| | Average | −0.84% | −1.67% |
| All | Average | −0.80% | −1.22% |

As shown in Table 1, it can be seen from the test results that, for Classes B to E, the PSNR is improved by 0.8% in the solution provided in the present disclosure compared with the original algorithm, and the SSIM is improved by 1.22% in the solution provided in the present disclosure compared with the original algorithm, which shows that the technical solution provided in the present disclosure can improve decoding performance.

In some embodiments, S430 may include:
that the decoder performs quality enhancement on a reference region including the reference block in the reference picture to obtain an enhancement picture, and then determines the enhancement block in the enhancement picture based on a position of the reference block in the reference region.

For example, the decoder performs quality enhancement on the reference picture by using a neural network to obtain the enhancement picture, and then determines the enhancement block in the enhancement picture based on the position of the reference block in the reference picture. In other alternative embodiments, the decoder may use a neural network to directly perform quality enhancement on the reference block.

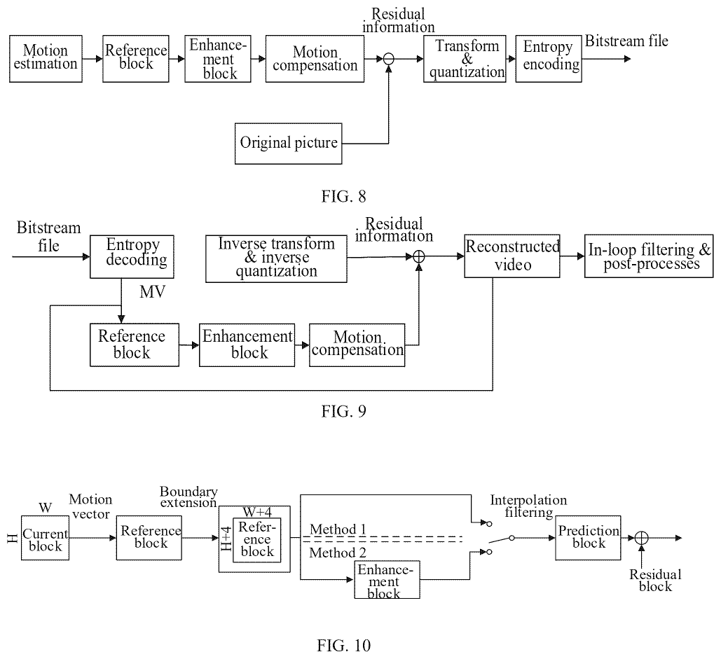

FIG. 8 is an example of an encoding process provided in embodiments of the present disclosure.

As shown in FIG. 8, at an encoding end, a reference block of a current block may be found based on motion estimation; then, an enhancement block that corresponds in position to the reference block is found in an enhancement picture, and the enhancement block is subjected to subsequent motion compensation to obtain a prediction block. The enhancement picture may be a picture obtained by performing quality enhancement on a reference region including the reference block in the reference picture. After obtaining the prediction block, the encoder performs subtraction on the prediction block and an original picture of the current block to obtain residual information of the current block, then performs transform and quantization on the residual information, and performs entropy encoding on the transformed and quantized information to obtain a bitstream file.

FIG. 9 is an example of a decoding process provided in embodiments of the present disclosure.

As shown in FIG. 9, at a decoding end, a reference block of a current block may be found in a reconstructed picture based on an MV obtained by decoding; then, an enhancement block that corresponds in position to the reference block is found in an enhancement picture, and the enhancement block is subjected to subsequent motion compensation to obtain a prediction block. The enhancement picture may be a picture obtained by performing quality enhancement on a reference region including the reference block in the reference picture. After obtaining the prediction block of the current block, the decoder may determine a reconstructed video based on the prediction block of the current block and residual information obtained by performing entropy decoding, inverse transform and inverse quantization on the current block; further, in-loop filtering or post-processes may be performed on the reconstructed video.

In some embodiments, the decoder determines a block in the enhancement picture that has a same position as the reference block in the reference region as the enhancement block.

For example, the decoder determines a sample in the enhancement picture that has a same position as a reference sample in the reference block as a position of a reference sample in the enhancement block. The reference sample in the reference block may be any sample in the reference block, including but not limited to a sample at a position of upper right corner, lower right corner, upper left corner, lower left corner, or center.

In some embodiments, S440 may include:
that the decoder performs boundary extension and interpolation filtering on the enhancement block to obtain the prediction block.

For example, after performing boundary extension on the enhancement block, the decoder uses a filter to perform filtering on each sample in the enhancement block whose boundary is extended, to obtain the prediction block. For example, inputs of the filter include a prediction sample and a neighboring sample, and a weight factor of the prediction sample and the neighboring sample is determined based on a positional relationship between the samples.

For example, in the case where the decoder determines a sample in the enhancement picture that has a same position as a reference sample in the reference block as a position of a reference sample in the enhancement block, the decoder directly performs boundary extension and interpolation filtering on the enhancement block when determining the prediction block based on the enhancement block, to obtain the prediction block.

FIG. 10 is an example of the decoder performing interpolation filtering based on an enhancement block provided in embodiments of the present disclosure.

As shown in FIG. 10, in a conventional motion compensation process, the decoder determines a reference block of the current block based on a vector. Since the fractional interpolation filter can cause the picture size to be reduced, it is necessary to extend a boundary of the reference samples by 4 samples before performing the interpolation filtering to ensure that the picture size is consistent before and after filtering. The decoder adds the filtered prediction block to the residual block to obtain a reconstructed block. Correspondingly, the encoder performs subtraction on the filtered prediction block and the original block to obtain a residual block, and then performs operations such as transform and quantization on the residual block. For the interpolation filtering process without introducing the enhancement block, as shown in Method 1 in the figure, subsequent operations such as interpolation filtering may be directly performed on the reference block. For the interpolation filtering process with the enhancement block in the present disclosure, as shown in Method 2 in the figure, a boundary extended picture of a block having the same position as the reference block may be found in the enhancement picture as the enhancement block, and then subsequent operations such as interpolation filtering may be performed on the enhancement block.

In some embodiments, S420 may include:
that the decoder partitions the current block into at least one sub-block, and then the decoder determines a motion parameter of the at least one sub-block based on the motion parameter of the current block, and determines at least one reference sub-block included in the reference block based on the motion parameter of the at least one sub-block; where S430 may include:
that the decoder determines a first region where the at least one reference sub-block is located based on a position of the at least one reference sub-block in the reference region, and then the decoder performs boundary extension on the first region to obtain a second region, and determines a block in the enhancement picture whose position corresponds to the second region as the enhancement block.

For example, the decoder partitions the current block into at least one sub-block, and then the decoder determines an MV of the at least one sub-block based on the MV of the current block, and determines at least one reference sub-block included in the reference block based on the MV of the at least one sub-block; where S430 may include:
that the decoder determines a first region where the at least one reference sub-block is located based on a position of the at least one reference sub-block in the reference region; then, the decoder performs boundary extension on the first region to obtain a second region, and determines a block in the enhancement picture whose position corresponds to the second region as the enhancement block.

For example, the decoder generates an MV for each sub-block through an affine model. Affine models include a 4-parameter model (2 CPMV) and a 6-parameter model (3 CPMV). The decoder determines the at least one reference sub-block based on the MV of each sub-block, and takes a region including the at least one reference sub-block as the first region; then, the decoder performs boundary extension on the first region to obtain the second region, and determines a region in the enhancement picture that is the same as the second region as the enhancement block.

In some embodiments, S440 may include:
that the decoder determines at least one sub-block in the enhancement block that have a same position as the at least one reference sub-block in the reference region as at least one enhancement sub-block included in the enhancement block, and then performs boundary extension and interpolation filtering on the at least one enhancement sub-block to obtain at least one prediction sub-block included in the prediction block.

For example, the decoder obtains prediction sub-blocks by performing interpolation filtering on all the reference sub-blocks, and the prediction sub-blocks constitute the prediction block.

In some embodiments, the first region is a minimum region including the at least one reference sub-block.

For example, the first region is a minimum rectangular region including the at least one reference sub-block. Alternatively, the first region may be a region of any other shape, which is not limited in the present disclosure.

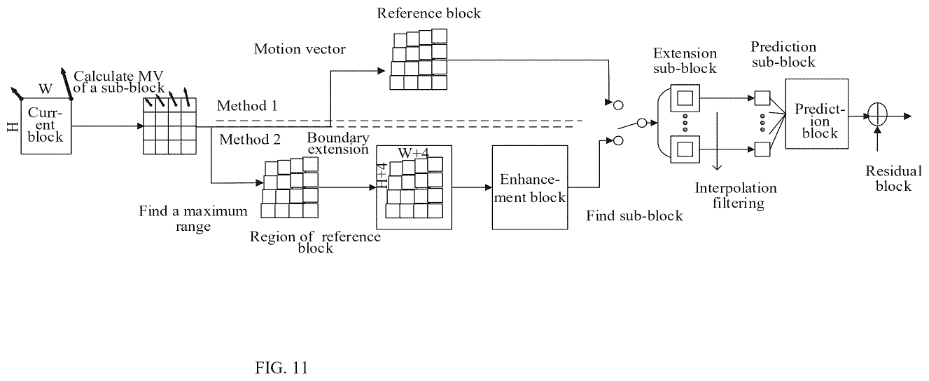

FIG. 11 is another example of a decoder performing interpolation filtering based on an enhancement block provided in embodiments of the present disclosure.

As shown in FIG. 11, in the affine motion compensation, for the interpolation filtering process without introducing the enhancement block, as shown in Method 1 in the figure, a current CU is partitioned into several 4×4 sub-blocks, and an MV of each sub-block is calculated through a 4-parameter or 6-parameter affine model. A corresponding reference sub-block is found for each current sub-block through the motion vector, and then operations such as boundary extension and fractional interpolation are performed on the reference sub-block to obtain a prediction sub-block; prediction sub-blocks constitute a prediction block. For the interpolation filtering process with the enhancement block in the present disclosure, as shown in Method 2 in the figure, a minimum rectangular region including all reference sub-blocks may be found, and an enhancement block at a corresponding position may be found in the enhancement picture; then, a corresponding extension sub-block is found in the enhancement block and fractional interpolation is performed, and the interpolated prediction sub-blocks constitute a prediction block.

In some embodiments, the reference region is an entire region or a partial region of the reference picture.

In some embodiments, the partial region is a region where any one of the following is located: a picture block, a sub-picture, a rectangular region (or tile), or a slice.

For example, the picture may be a decoded block, and the decoded block may be a CU or CTU.

For example, the reference picture may be partitioned into one or more, and data encoding of each slice is independent.

For example, the reference picture may be partitioned into several rectangular regions in horizontal and vertical directions. These rectangular regions are referred to as tiles. The partitioned tiles are not required to be evenly distributed. Usually, each tile contains approximately the same CTU data. Each tile may be encoded independently. During encoding, CTUs included in each tile are encoded in a scanning order.

It should be understood that the reference picture may be partitioned into several slices or several tiles, and the purposes of partitioning in these two ways are both to perform independent encoding. Some slices each may include multiple tiles, or some tiles each may include multiple slices. The number of CTUs included in a tile and the number of CTUs included in a slice do not affect each other.

In some embodiments, S430 may include:
that the decoder performs feature extraction on the reference region to obtain a residual picture, and then weights the reference region and the residual picture to obtain the enhancement picture.

For example, a weight of the reference region and a weight of the residual picture may be predefined weight values.

For example, after obtaining the residual picture, the decoder may directly perform addition on the reference region and the residual picture to obtain the enhancement picture.

In some embodiments, the decoder determines a first parameter for performing feature extraction on the reference region based on a size of the current block, and then performs feature extraction on the reference region based on the first parameter to obtain the residual picture.

For example, the decoder may determine a first parameter set for performing feature extraction on the reference region based on the size of the current block. The first parameter set may include at least one parameter, and the at least one parameter may include the first parameter. The parameter(s) in the first parameter set may be parameter(s) involved in various operations performed on the reference region. In other words, the first parameter is related to an operation process used for performing feature extraction on the reference region.

In some embodiments, the decoder determines a parameter corresponding to the minimum side length of the current block as the first parameter.

For example, the decoder may determine the parameter corresponding to the minimum side length of the current block as the first parameter based on a mapping relationship between multiple side lengths and multiple parameters. The mapping relationship may be predefined information.

In some embodiments, the decoder performs feature extraction on the reference region to obtain first feature information, performs multi-scale feature extraction on the first feature information and performs concatenation on the extracted multi-scale feature information to obtain second feature information, determines third feature information based on the second feature information and feature information obtained by performing feature extraction on the second feature information, performs multi-scale feature extraction on the third feature information and performs concatenation on the extracted multi-scale feature information to obtain fourth feature information, and then converts the fourth feature information into feature information having the same number of channels as the reference region to obtain the residual picture.

For example, the first feature information and the second feature information have the same number of channels.

For example, the second feature information and the third feature information have the same number of channels.

For example, the third feature information and the fourth feature information have the same number of channels.

For example, the first feature information, the second feature information, or the third feature information includes feature information on multiple channels, and the number of channels of the reference region is one or more. For example, in a case where the reference picture is a component reference picture, the number of channels of the reference region may be 1.

In some embodiments, S430 may include:
that the decoder performs quality enhancement on the reference region by using a dense-residual variable-size convolutional neural network (Dense-RVCNN) to obtain the enhancement picture.

For example, the Dense-RVCNN may be a densely connected neural network for performing residual convolution.

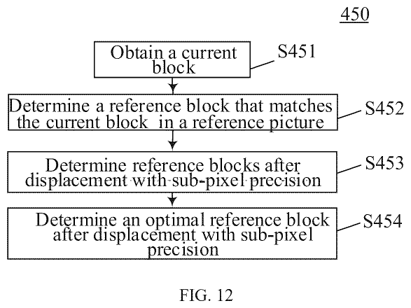

FIG. 12 is a schematic flowchart of an inter prediction process 450 without introducing an enhancement block provided in embodiments of the present disclosure.

As shown in FIG. 12, the inter prediction process 450 without introducing the enhancement block may include the following.

In S451, a current block is obtained.

In S452, a reference block that matches the current block is determined in a reference picture.

When performing inter prediction on the current block, the encoder firstly finds a block that is most similar to the current block as the reference block by using motion estimation. For example, a Tzsearch search may be performed on the constructed reference picture, and a picture block (with a smallest rate distortion (RD) cost) that is most similar to the current block is the reference block. Accordingly, when performing inter prediction on the current block, the decoder can determine the reference block of the current block based on a motion vector obtained by decoding a bitstream.

In S453, reference blocks after displacement with sub-pixel precision are determined.

After determining the reference block, the encoder performs motion compensation on the reference block to obtain multiple reference blocks after displacement with sub-pixel precision. Accordingly, after determining the reference block, the decoder determines multiple reference blocks after displacement with sub-pixel precision by performing motion compensation on the reference block.

In S454, an optimal reference block after displacement with sub-pixel precision is determined.

After obtaining the multiple reference blocks after displacement with sub-pixel precision, the encoder determines a reference block (with the smallest RD cost) that is most similar to the current block among the multiple reference blocks after displacement with sub-pixel precision as the optimal reference block after displacement with sub-pixel precision. Accordingly, after obtaining the multiple reference blocks after displacement with sub-pixel precision, the decoder may also determine a reference block (with the smallest RD cost) that is most similar to the current block among the multiple reference blocks after displacement with sub-pixel precision as the optimal reference block after displacement with sub-pixel precision. The optimal reference block after displacement with sub-pixel precision may be used as a prediction block of the current block.

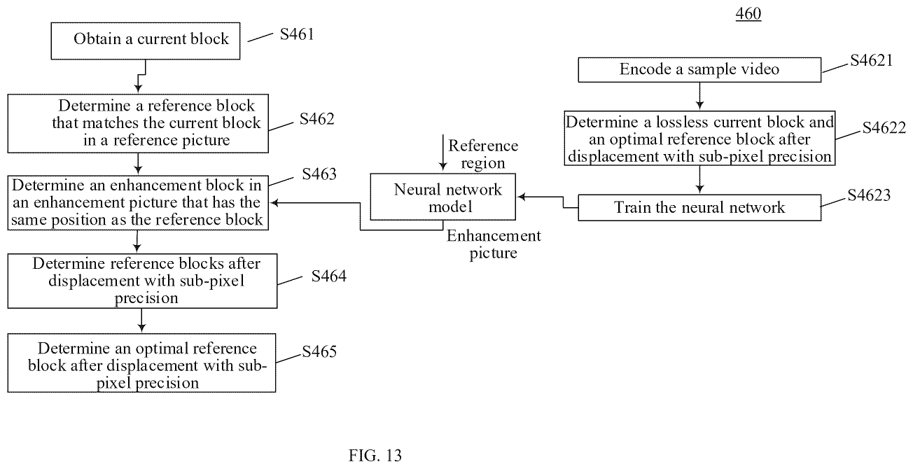

FIG. 13 is a schematic flowchart of an inter prediction process 460 with an enhancement block provided in embodiments of the present disclosure.

As shown in FIG. 13, the inter prediction process 460 with the enhancement block may include the following.

In S461, a current block is obtained.

In S462, a reference block that matches the current block is determined in a reference picture.

When performing inter prediction on the current block, the encoder firstly finds a block that is most similar to the current block as the reference block by using motion estimation. For example, a Tzsearch search may be performed on the constructed reference picture, and a picture block (with the smallest RD cost) that is most similar to the current block is the reference block. Accordingly, when performing inter prediction on the current block, the decoder can determine the reference block of the current block based on a motion vector obtained by decoding a bitstream.

In S463, a block in an enhancement picture that has the same position as the reference block is determined as an enhancement block.

When the reference picture is constructed, a neural network is used to perform quality enhancement on a reference region including the reference block in the reference picture to obtain the enhancement picture. An enhancement block having the same position as the reference block is found from the enhancement picture, and the enhancement block is used to replace the original reference block for subsequent operations.

In S464, reference blocks after displacement with sub-pixel precision are determined.

After determining the reference block, the encoder performs motion compensation on the reference block to obtain multiple reference blocks after displacement with sub-pixel precision. Accordingly, after determining the reference block, the decoder may also determine multiple reference blocks after displacement with sub-pixel precision by performing motion compensation on the reference block.

In S465, an optimal reference block after displacement with sub-pixel precision is determined.

After obtaining the multiple reference blocks after displacement with sub-pixel precision, the encoder may determine a reference block (with the smallest RD cost) that is most similar to the current block among the multiple reference blocks after displacement with sub-pixel precision as the optimal reference block after displacement with sub-pixel precision. Accordingly, after obtaining the multiple reference blocks after displacement with sub-pixel precision, the decoder may also determine a reference block (with the smallest RD cost) that is most similar to the current block among the multiple reference blocks after displacement with sub-pixel precision as the optimal reference block after displacement with sub-pixel precision. The optimal reference block after displacement with sub-pixel precision may be used as a prediction block of the current block.

For example, before S463, the inter prediction process 460 with the enhancement block may further include a process for training a neural network (or a neural network trained in advance). The process for training the neural network may include the following.

In S4621, a sample video is encoded.

For example, 650 videos may be randomly selected from a BVI-DVC dataset (which is a dataset containing a large number of scenarios YUV video files). The first 32 pictures of these videos are encoded by using the VTM-9.3 encoder in which an encoding mode is set to be an LDP mode and a quantization parameter (Qp) is set to be 22, so as to generate a bitstream. Alternatively, a configuration mode of a random access (RA) and low delay B (LB) may be adopted, and the present disclosure does not limit thereto.

In S4622, a lossless current block and an optimal reference block after displacement with sub-pixel precision are determined.

For example, for the current block, the bitstream includes motion vector information with integer-pixel precision and motion vector information with fractional-pixel precision, and a training apparatus may derive an integer-pixel position of the reference block from an integer-pixel position of the current block. Then, the sub-pixel interpolation filter is used to perform sub-pixel displacement on the integer-pixel reference block to obtain the prediction block.

For example, the prediction block after displacement with sub-pixel precision in the dataset is used as an input of the neural network, and the lossless current block is used as a true value to train the neural network.

In S4623, the neural network is trained.

For example, during training of the neural network, a loss function may be a mean square error (MSE) loss function, an initial learning rate may be set to 0.0001, the learning rate may be changed to 0.1 times a previous learning rate after every 60 cycles, and each network is trained for 180 cycles. The prediction blocks of 16×16, 32×32, and 64×64 sizes are used for training three neural networks of DENSE-RVCNN1, DENSE-RVCNN2, and DENSE-RVCNN3, respectively.

In some embodiments, the decoder determines a network parameter used by the Dense-RVCNN based on a size of the current block, and then determines the enhancement picture based on the network parameter used by the Dense-RVCNN.

For example, network parameters of the Dense-RVCNN may include multiple sets of network parameters. When calling the Dense-RVCNN, the decoder may determine the network parameter used by the Dense-RVCNN based on the size of the current block, and then perform quality enhancement on the reference region by using the network parameter used by the Dense-RVCNN to obtain the enhancement picture.

For example, network parameters of the Dense-RVCNN include multiple sets of network parameters. When calling the Dense-RVCNN, the decoder may directly call the multiple sets of network parameters of the Dense-RVCNN to perform quality enhancement on the reference region, so as to obtain multiple quality-enhanced pictures; then, the decoder may determine the network parameter used by the Dense-RVCNN based on the size of the current block, and determine the enhancement picture from the multiple quality-enhanced pictures based on the network parameter used by the Dense-RVCNN. For example, a picture corresponding to the network parameter used by the Dense-RVCNN may be determined as the enhancement picture.

In these embodiments, the decoder determines the network parameter used by the Dense-RVCNN based on the size of the current block, which can reduce the complexity of the decoder calling the Dense-RVCNN, thereby improving the decoding performance of the decoder.

In some embodiments, the decoder determines a parameter corresponding to a minimum side length of the current block as the network parameter used by the Dense-RVCNN.

For example, in a case where the minimum side length of the current block is greater than or equal to a preset threshold, the decoder determines the parameter corresponding to the minimum side length of the current block as the network parameter used by the Dense-RVCNN.

Assuming that enhancement pictures are introduced for all rectangular blocks with the sizes greater than 16×16 in the reference region, the decoder may determine that the reference block is replaced by the enhancement block in the following way.

For a rectangular block with a minimum side length of 16, an enhancement block in the enhancement picture 1 output by the DENSE-RVCNN1 model may be used to replace the reference block; for a rectangular block with a minimum side length of 32, an enhancement block in the enhancement picture 2 output by the DENSE-RVCNN2 model may be used to replace the reference block; for rectangular blocks with minimum side lengths of 64 and 128, an enhancement block in the enhancement picture 3 output by the DENSE-RVCNN3 model may be used to replace the reference block.

In some embodiments, the Dense-RVCNN includes at least one of the following:
an input layer configured to perform feature extraction on the reference region;
at least one residual variable-size convolutional block (RVCB) structure configured to perform multi-scale feature extraction and feature concatenation on feature information input into the at least one RVCB structure;
a dense network (DenseNet) structure configured to perform feature extraction on feature information input into the DenseNet structure;
an output layer configured to convert an input feature information into feature information having the same number of channels as the reference region and to weight the reference region and the converted feature information.

For example, the input layer may include a convolutional layer and an activation layer.

For example, the RVCB structure may include a structure for performing multi-scale feature extraction on the input feature information and a concatenation layer for performing concatenation on the extracted feature information. The structure for performing multi-scale extraction may be implemented by convolutional layers corresponding to convolution kernels of different sizes.

For example, the DenseNet structure is a convolutional neural network of a dense connection. There is a direct connection between any two layers of the DenseNet structure. That is, an input of each layer is a union of outputs of all previous layers, and a feature picture learned by the layer is also directly passed to all subsequent layers as an input. Each layer of the DenseNet structure is directly connected to a previous layer, which achieves reuse of the features. Each layer of the DenseNet structure may be designed to be particularly narrow, i.e., only learn a very small number of feature pictures (the most extreme case is that only one feature picture is learned by each layer), so as to reduce redundancy.

For example, the output layer may include a convolutional layer, and the convolutional layer can extract feature information having the same number of channels as the reference region.

In some embodiments, the at least one RVCB structure includes a plurality of RVCB structures; the input layer is connected to an input end of the DenseNet structure through a part of the plurality of RVCB structures, and an output end of the DenseNet structure is connected to the output layer through another part of the plurality of RVCB structures.

For example, the input layer may be connected to the input end of the DenseNet structure through half of the plurality of RVCB structures, and the output end of the DenseNet structure may be connected to the output layer through the other half of the plurality of RVCB structures.

Alternatively, the number of RVCB structures used to connect the input layer and the input end of the DenseNet structure may be different from the number of RVCB structures used to connect the output end of the DenseNet structure and the output layer, and the present disclosure does not limit thereto.

In some embodiments, the RVCB structure includes:
a plurality of first feature extraction layers connected in parallel, where the first feature extraction layer includes a convolutional layer, convolution kernels of convolutional layers in different first feature extraction layers of the plurality of first feature extraction layers are different, and the number of channels of the convolutional layer in the first feature extraction layer is a ratio of the number of channels of feature information input for the first feature extraction layer to the number of the plurality of first feature extraction layers;
a first concatenation layer configured to perform feature concatenation on feature information output by the plurality of first feature extraction layers;
a first convolutional layer configured to perform feature extraction on feature information output by the first concatenation layer; and
a skip connection layer configured to weight the feature information input for the RVCB structure and feature information output by the first convolutional layer.

For example, the first feature extraction layer may include a convolutional layer and a subsequent connected activation layer.

For example, the first convolutional layer may be an optional convolutional layer.

For example, the skip connection layer may directly add the feature information input for the RVCB structure and the feature information output by the first convolutional layer to obtain feature information output by the RVCB structure.

In some embodiments, the DenseNet structure includes:
a plurality of second feature extraction layers connected in series, the second feature extraction layer including a convolutional layer;
a plurality of second concatenation layers, where two adjacent second feature extraction layers in the plurality of second feature extraction layers are connected through a second concatenation layer, and any one of the plurality of second concatenation layers is configured to perform feature concatenation on the feature information input for the DenseNet structure and feature information output by a previous second feature extraction layer of the any one second concatenation layer; and
a second convolutional layer, where a last second feature extraction layer in the plurality of second feature extraction layers is connected to the second convolutional layer through a last second concatenation layer in the plurality of second concatenation layers, and the second convolutional layer is configured to convert feature information output by the last second concatenation layer into feature information having the same number of channels as the feature information input for the DenseNet structure.

For example, the second feature extraction layer may include a convolutional layer and a subsequent connected activation layer.

For example, the plurality of second concatenation layers are configured to achieve the dense connection of the plurality of second feature extraction layers.

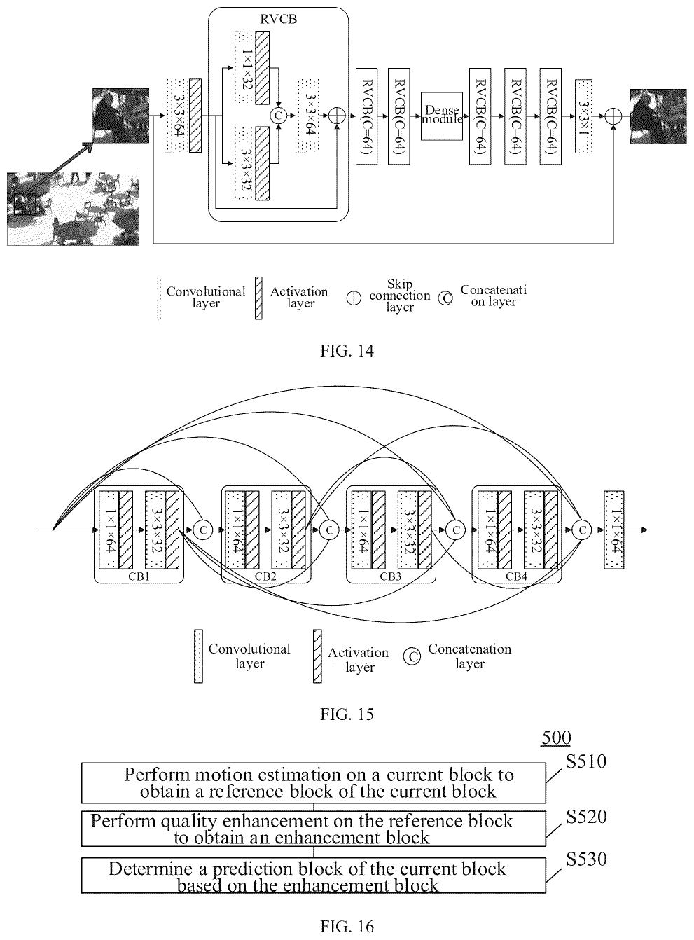

FIG. 14 is a schematic structural diagram of the Dense-RVCNN provided in embodiments of the present disclosure.

As shown in FIG. 14, the Dense-RVCNN consists of 6 RVCB structures, 1 DenseNet structure, a convolutional layer and a skip connection layer that are located at the beginning and end.

For the Dense-RVCNN, an integer-pixel reference block before motion compensation is taken as an input, and passes through a convolutional layer with a first layer convolution kernel of 3×3 and LeakyReLU. This process may be expressed as:

$${F}_{1} = L R e L U ( {W}_{0} \cdot X ) = max ( 0 , {W}_{0} \cdot X ) + α \cdot min ( {W}_{0} \cdot X ) .$$

Here, w₀ represents the convolution kernel of the first layer, α represents a slope of the LeakyReLU function on a negative semi-axis, and X represents the input of the neural network; Fᵢ represents an output of the first layer, and LReLU( ) represents a nonlinear mapping function of LeakyReLU.

The RVCB structure adopts a multi-size convolution structure.

In a case where feature data enters the RVCB structure, the feature data is first converted into two sets of 32-channel feature data by using a 3×3 convolution kernel, a 1×1 convolution kernel, and LeakyReLU. Subsequently, the two sets of feature data are concatenated in a channel dimension and then converted into 64-channel feature data through 3×3 convolution. Finally, this set of data is added to the input of the module through skip connection to obtain the output of the module. This process may be expressed as:

$${F}_{i , 1 \_ 1} = LReLU ( {W}_{i , 1 \_ 1} \cdot {F}_{i} ) ;$$

$${F}_{i , 1 \_ 3} = L R e L U ( {W}_{i , 1 \_ 3} \cdot {F}_{i} ) ;$$

$${F}_{i , 2} = {W}_{i , 2} \cdot cat ( \cdot {F}_{i , 1 \_ 3} , {F}_{i , 1 \_ 3} ) ;$$

$${F}_{i + 1} = {F}_{i} + {F}_{i , 2} .$$

Here, 1≤i≤7, and i≠4, Fᵢ is feature information input into an i-th RVCB structure, W_{i, 1_1} is a parameter of a first layer convolution kernel of 1×1 in the i-th RVCB structure, W_{i, 1_3} is a parameter of a first layer convolution kernel of 3×3 in the i-th RVCB structure, and W_{i, 2} is a parameter of a second layer convolution kernel in the i-th RVCB structure. cat( ) represents concatenation of feature data.

FIG. 15 is a schematic structural diagram of a DenseNet structure in the Dense-RVCNN provided in embodiments of the present disclosure.

As shown in FIG. 15, the DenseNet structure consists of convolutional blocks (CBs) and a convolutional layer of 1×1. The CB is also referred to as a feature extraction layer. Each CB contains a convolutional layer of 1×1, a convolutional layer of 3×3, and a LeakyReLU function. The convolutional layer of 1×1 is used to compress the number of channels of an input feature to 64 channels, so as to facilitate processing of 3×3 convolution. The calculation formulas of the entire DenseNet structure are as follows:

$${F}_{4 , j} = C {B}_{j} ( c a t ( {F}_{4 , 0} , … , {F}_{4 , j - 1} ) ) = LReLU ( {W}_{4 , j \_ 2} \cdot LReLU ( {W}_{4 , j \_ 1} \cdot cat ( {F}_{4 , 0} , … , {F}_{4 , j - 1} ) ) ) ;$$

$${F}_{5} = {W}_{4 , 5} \cdot {F}_{4 , 4} .$$

Here, 1≤j≤4 is feature information input for the DenseNet structure, F_{4,0} is feature information output by a j-th CB, and F₅ is feature information output by the DenseNet structure; W_{4, j_1} is a parameter of a first layer convolution kernel in the j-th CB, W_{4, j_2} is a parameter of a second layer convolution kernel in the j-th CB, and W_{4, 5} is a parameter of a last layer convolution kernel in the DenseNet structure. In each CB, the number of channels of the 1×1 convolution kernel is 64, and the number of channels of the 3×3 convolution kernel is 32; and the number of channels of the last layer convolution kernel in the DenseNet structure is 64.

Finally, a convolutional layer with a convolution kernel of 3×3 and a channel number of 1 is used to compress all feature pictures into a residual picture. The residual picture is added to an input picture to obtain a final output picture. The process is as follows:

$${F}_{9} = {W}_{9} \cdot {F}_{8} ;$$

$$Y = {F}_{9} + X .$$

Here, Y is an output of the neural network, F₈ is feature information output by a last RVCB structure, w₉ is a parameter of the last convolution kernel, and X represents an input of the neural network.

In some embodiments, the motion parameter includes at least one of the following: a motion vector of the current block or an index of the reference picture.

For example, the decoder may determine the motion vector of the current block by decoding the bitstream, and determine the reference block of the current block in a predefined reference picture based on the motion vector. The predefined reference picture may be a decoded picture determined according to a preset rule.

For example, the decoder may determine the index by decoding the bitstream, and determine the reference block of the current block in the reference picture indicated by the index.

For example, the decoder may determine the motion vector of the current block and the index by decoding the bitstream, and determine the reference block of the current block in the reference picture indicated by the index based on the motion vector. The predefined reference picture may be a decoded picture determined according to a preset rule.

The decoding method according to the embodiments of the present disclosure is described in detail above from the perspective of the decoder. An encoding method according to the embodiments of the present disclosure will be described below from the perspective of the encoder with reference to FIG. 16.

FIG. 16 is a schematic flowchart of an encoding method 500 provided in embodiments of the present disclosure. It should be understood that the encoding method 500 can be performed by the encoder. For example, the encoding method 500 may be performed by the video encoder 112 shown in FIG. 1, or performed by the video encoder 200 shown in FIG. 2. For the convenience of description, the following description is made by taking the encoder as an example.

As shown in FIG. 16, the encoding method 500 may include the following.

In S510, the encoder performs motion estimation on a current block to obtain a reference block of the current block.

In S520, the encoder performs quality enhancement on the reference block to obtain an enhancement block.

In S530, the encoder determines a prediction block of the current block based on the enhancement block.

In some embodiments, S520 may include:
that the encoder performs quality enhancement on a reference region including the reference block in a reference picture to obtain an enhancement picture, and then determines the enhancement block in the enhancement picture based on a position of the reference block in the reference region.

In some embodiments, the encoder determines a block in the enhancement picture that has the same position as the reference block in the reference region as the enhancement block.

In some embodiments, S530 may include:
that the encoder performs boundary extension and interpolation filtering on the enhancement block to obtain the prediction block.

In some embodiments, S510 may include:
that the encoder partitions the current block into at least one sub-block, performs motion estimation on the current block to determine a motion parameter of the current block, determines a motion parameter of the at least one sub-block based on the motion parameter of the current block, and then determines at least one reference sub-block included in the reference block based on the motion parameter of the at least one sub-block; where S520 may include:
that the encoder determines a first region where the at least one reference sub-block is located based on a position of the at least one reference sub-block in the reference region, performs boundary extension on the first region to obtain a second region, and then determines a block in the enhancement picture whose position corresponds to the second region as the enhancement block.

In some embodiments, S530 may include:
that the encoder determines at least one sub-block in the enhancement block that have the same position as the at least one reference sub-block in the reference region as at least one enhancement sub-block included in the enhancement block, and then performs boundary extension and interpolation filtering on the at least one enhancement sub-block to obtain at least one prediction sub-block included in the prediction block.

In some embodiments, the first region is a minimum region including the at least one reference sub-block.

In some embodiments, the reference region is an entire region or a partial region of the reference picture.

In some embodiments, the partial region is a region where any one of the following is located: a picture block, a sub-picture, a rectangular region, or a slice.

In some embodiments, the encoder performs feature extraction on the reference region to obtain a residual picture, and then weights the reference region and the residual picture to obtain the enhancement picture.

In some embodiments, the encoder determines a first parameter for performing feature extraction on the reference region based on a size of the current block, and then performs feature extraction on the reference region based on the first parameter to obtain the residual picture.

In some embodiments, the encoder determines a parameter corresponding to a minimum side length of the current block as the first parameter.

In some embodiments, the encoder performs feature extraction on the reference region to obtain first feature information; then, performs multi-scale feature extraction on the first feature information and performs concatenation on the extracted multi-scale feature information to obtain second feature information; determines third feature information based on the second feature information and feature information obtained by performing feature extraction on the second feature information; performs multi-scale feature extraction on the third feature information and performs concatenation on the extracted multi-scale feature information to obtain fourth feature information; and converts the fourth feature information into feature information having a same number of channels as the reference region to obtain the residual picture.

In some embodiments, the encoder performs quality enhancement on the reference region by using a dense-residual variable-size convolutional neural network (Dense-RVCNN) to obtain the enhancement picture.

In some embodiments, the encoder determines a network parameter used by the Dense-RVCNN based on a size of the current block, and then determines the enhancement picture based on the network parameter used by the Dense-RVCNN.

In some embodiments, the encoder determines the parameter corresponding to the minimum side length of the current block as the network parameter used by the Dense-RVCNN.

In some embodiments, the Dense-RVCNN includes at least one of the following:
an input layer configured to perform feature extraction on the reference region;
at least one residual variable-size convolutional block (RVCB) structure configured to perform multi-scale feature extraction and feature concatenation on feature information input into the at least one RVCB structure;
a dense network (DenseNet) structure configured to perform feature extraction on feature information input into the DenseNet structure; and
an output layer configured to convert an input feature information into feature information having the same number of channels as the reference region and to weight the reference region and the converted feature information.

In some embodiments, the at least one RVCB structure includes a plurality of RVCB structures; the input layer is connected to an input end of the DenseNet structure through a part of the plurality of RVCB structures, and an output end of the DenseNet structure is connected to the output layer through another part of the plurality of RVCB structures.

In some embodiments, the RVCB structure includes:
a plurality of first feature extraction layers connected in parallel, where the first feature extraction layer includes a convolutional layer, convolution kernels of convolutional layers in different first feature extraction layers of the plurality of first feature extraction layers are different, and the number of channels of the convolutional layer in the first feature extraction layer is a ratio of the number of channels of feature information input for the first feature extraction layer to the number of the plurality of first feature extraction layers;
a first concatenation layer configured to perform feature concatenation on feature information output by the plurality of first feature extraction layers;
a first convolutional layer configured to perform feature extraction on feature information output by the first concatenation layer; and
a skip connection layer configured to weight the feature information input for the RVCB structure and feature information output by the first convolutional layer.

In some embodiments, the DenseNet structure includes:
a plurality of second feature extraction layers connected in series, the second feature extraction layer including a convolutional layer;
a plurality of second concatenation layers, where two adjacent second feature extraction layers in the plurality of second feature extraction layers are connected through a second concatenation layer, and any one of the plurality of second concatenation layers is configured to perform feature concatenation on the feature information input for the DenseNet structure and feature information output by a previous second feature extraction layer of the any one second concatenation layer; and
a second convolutional layer, where a last second feature extraction layer in the plurality of second feature extraction layers is connected to the second convolutional layer through a last second concatenation layer in the plurality of second concatenation layers, and the second convolutional layer is configured to convert feature information output by the last second concatenation layer into feature information having the same number of channels as the feature information input for the DenseNet structure.

In some embodiments, the method 500 may further include:
encoding a motion parameter of the current block;
where the motion parameter of the current block includes at least one of the following: a motion vector of the current block or an index of the reference picture.

It should be understood that the encoding method may be understood as the inverse process of the decoding method. Therefore, the scheme of the encoding method 500 may refer to the relevant content of the decoding method 400, which will not be repeated in the present disclosure for the convenience of description.

The above describes in detail the decoding and encoding methods according to the embodiments of the present disclosure from the perspectives of the decoder and the encoder. The following will describe a method for training a neural network provided according to the embodiments of the present disclosure from the perspective of the neural network with reference to FIG. 17.

FIG. 17 is a schematic flowchart of a neural network training method 600 provided in embodiments of the present disclosure.

It should be understood that the training method 600 may be performed by any one of electronic devices with data processing capabilities. The following description will be made by using a training apparatus as an example.

In addition, the training method 600 provided in the present disclosure may be combined with the decoding method 400 or the encoding method 500. For example, the training apparatus trains a neural network by using the training method 600; after the neural network is trained, the decoder performs quality enhancement on the reference region in the reference picture by using the neural network to obtain the enhancement picture with enhanced quality, and then determines the enhancement block corresponding to the reference block in the enhancement picture. For another example, the training apparatus trains a neural network by using the training method 600; after the neural network is trained, the encoder performs quality enhancement on the reference region in the reference picture by using the neural network to obtain the enhancement picture with enhanced quality, and then determines the enhancement block corresponding to the reference block in the enhancement picture.

In addition, when the neural network is trained, a dataset used is not specifically limited in the present disclosure.

As shown in FIG. 17, the neural network training method 600 may include the following.

In S610, the training apparatus encodes a sample video to obtain a bitstream.

For example, 650 videos may be randomly selected from a BVI-DVC dataset (which is a dataset containing a large number of scenarios YUV video files). The first 32 pictures of these videos are encoded by using the VTM-9.3 encoder in which an encoding mode is set to be an LDP mode and a quantization parameter (Qp) is set to be 22, so as to generate a bitstream. Alternatively, a configuration mode of a random access (RA) and low delay B (LB) may be adopted, and the present disclosure does not limit thereto.

In S620, the training apparatus decodes the bitstream to determine a prediction block of the current block.

For example, for the current block, the bitstream includes motion vector information with integer-pixel precision and motion vector information with fractional-pixel precision, and the training apparatus may derive an integer-pixel position of the reference block from an integer-pixel position of the current block. Then, the sub-pixel interpolation filter is used to perform sub-pixel displacement on the integer-pixel reference block to obtain the prediction block.

For example, the prediction block after displacement with sub-pixel precision in the dataset is used as an input of the neural network, and the lossless current block is used as a true value to train the neural network.

In S630, the training apparatus trains the neural network based on the label of the current block and the prediction block.

For example, during training of the neural network, a loss function may be a mean square error (MSE) loss function, an initial learning rate may be set to 0.0001, the learning rate may be changed to 0.1 times a previous learning rate after every 60 cycles, and each network is trained for 180 cycles. The prediction blocks of 16×16, 32×32, and 64×64 sizes are used for training three neural networks of DENSE-RVCNN1, DENSE-RVCNN2, and DENSE-RVCNN3, respectively.

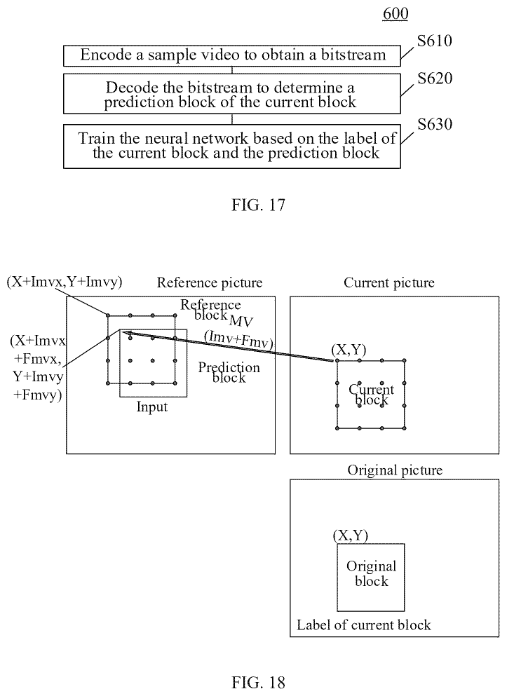

FIG. 18 is an example of an input and label during training of a neural network provided in embodiments of the present disclosure.

As shown in FIG. 18, for the current block, the bitstream includes the motion vector information with integer-pixel precision and the motion vector information with fractional-pixel precision. The motion vector information with integer-pixel precision includes Imvx and Imvy, and the motion vector information with integer-pixel precision includes Fmvx and Fmvy. The training apparatus may derive the integer-pixel position of the reference block from the reference picture by combining the integer-pixel position of the current block and the motion vector information with integer-pixel precision. That is, the integer-pixel position of the reference block is: (X+Imvx, Y+Imvy). Then, the sub-pixel interpolation filter is used to perform sub-pixel displacement on the integer-pixel reference block to obtain the position of the prediction block, and the position of the prediction block is: (X+Imvx+Fmvx, Y+Imvy+Fmvy).

In some embodiments, S620 may include:
that the training apparatus determines prediction blocks of multiple sizes; where S630 may include:
that the training apparatus trains the neural network based on the label of the current block and the prediction blocks of multiple sizes to obtain network parameters corresponding to the multiple sizes.

The sizes of the reference blocks vary from 4×4 to 128×128, and the reference blocks are all rectangular blocks; and therefore, in the present disclosure, the reference blocks are classified into large, medium, and small blocks based on the sizes of the reference blocks. The small blocks are rectangular blocks with a minimum side length of 16, including rectangular blocks with sizes of 16×16, 16×32, 32×16, 16×64, and 64×16. The medium blocks are rectangular blocks with a minimum side length of 32, including rectangular blocks with sizes of 32×32, 32×64, and 64×32. The large blocks are rectangular blocks with a minimum side length of 64, including rectangular blocks with sizes of 64×64, 64×128, 128×64, and 128×128. Three different datasets are generated for the large, medium, and small rectangular blocks to train three sets of network parameters. Since there are too many rectangular blocks partitioned in the video, only square prediction blocks with sizes of 16×16, 32×32, and 64×64 are selected to generate, with an original current block, the three datasets. When the neural network model is trained by using these three datasets, the quality enhancement is performed on the same reference region in the same reference picture to generate three different enhancement pictures, and the large, medium and small blocks may be used to determine the enhancement blocks in different enhancement pictures.

In some embodiments, the prediction blocks of multiple sizes include multiple prediction blocks with different minimum side lengths.

The preferred implementations of the present disclosure are described in detail above with reference to the accompanying drawings. However, the present disclosure is not limited to the specific details in the implementations mentioned above. Within the technical concept of the present disclosure, various simple modifications may be made to the technical solution of the present disclosure, and these simple modifications all fall within the protection scope of the present disclosure. For example, the various specific technical features described in the specific implementations involved above may be combined in any suitable manner without contradiction. In order to avoid unnecessary repetition, the various possible combinations are not described additionally in the present disclosure. For another example, different implementations of the present disclosure can also be combined arbitrarily, as long as the combination does not violate the concept of the present disclosure, which should also be regarded as the contents disclosed in the present disclosure. It should also be understood that, in the various method embodiments of the present disclosure, the magnitude of a serial number of each of the above processes does not imply a sequential order of execution, and that the order of execution of the processes should be determined by their function and inherent logic without constituting any limitation of the process of implementing the embodiments of the present disclosure. In addition, in the embodiments of the present disclosure, the term “and/or” is only a description of an association relationship of associated objects, which indicates that there may be three kinds of relationships. Specifically, A and/or B may represent three situations that: A exists alone, both A and B exist, and B exists alone. Moreover, the character “/” in the present disclosure generally indicates that the associated objects before and after this character are in an “or” relationship.

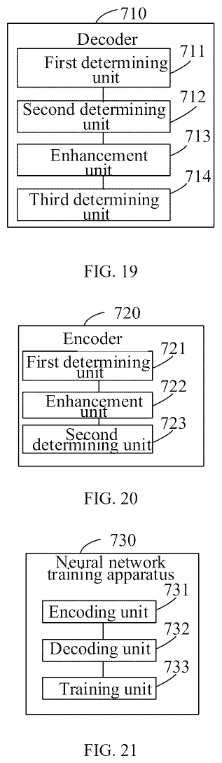

The method embodiments of the present disclosure are described in detail above, and the apparatus embodiments of the present disclosure will be described in detail below with reference to FIGS. 19 to 22.

FIG. 19 is a schematic block diagram of a decoder 710 provided in embodiments of the present disclosure.

As shown in FIG. 19, the decoder 710 may include:
a first determining unit 711 configured to decode a bitstream to determine a motion parameter of a current block;
a second determining unit 712 configured to determine a reference block of the current block in a reference picture of the current block based on the motion parameter of the current block;
an enhancement unit 713 configured to perform quality enhancement on the reference block to obtain an enhancement block; and
a third determining unit 714 configured to determine a prediction block of the current block based on the enhancement block.

In some embodiments, the enhancement unit 713 is configured to:
perform quality enhancement on a reference region including the reference block in the reference picture to obtain an enhancement picture; and
determine the enhancement block in the enhancement picture based on a position of the reference block in the reference region.

In some embodiments, the enhancement unit 713 is configured to:
determine a block in the enhancement picture that has a same position as the reference block in the reference region as the enhancement block.

In some embodiments, the third determining unit 714 is configured to:
perform boundary extension and interpolation filtering on the enhancement block to obtain the prediction block.

In some embodiments, the second determining unit 712 is configured to:
partition the current block into at least one sub-block;
determine a motion parameter of the at least one sub-block based on the motion parameter of the current block; and
determine at least one reference sub-block included in the reference block based on the motion parameter of the at least one sub-block.

The enhancement unit 713 is configured to:
determine a first region where the at least one reference sub-block is located based on a position of the at least one reference sub-block in the reference region;
perform boundary extension on the first region to obtain a second region; and
determine a block in the enhancement picture whose position corresponds to the second region as the enhancement block.

In some embodiments, the third determining unit 714 is configured to:
determine at least one sub-block in the enhancement block that have a same position as the at least one reference sub-block in the reference region as at least one enhancement sub-block included in the enhancement block; and
perform boundary extension and interpolation filtering on the at least one enhancement sub-block to obtain at least one prediction sub-block included in the prediction block.

In some embodiments, the first region is a minimum region including the at least one reference sub-block.

In some embodiments, the reference region is an entire region or a partial region of the reference picture.

In some embodiments, the partial region is a region where any one of the following is located: a picture block, a sub-picture, a rectangular region, or a slice.

In some embodiments, the enhancement unit 713 is configured to:
perform feature extraction on the reference region to obtain a residual picture; and
weight the reference region and the residual picture to obtain the enhancement picture.

In some embodiments, the enhancement unit 713 is configured to:
determine a first parameter for performing feature extraction on the reference region based on a size of the current block; and
perform feature extraction on the reference region based on the first parameter to obtain the residual picture.

In some embodiments, the enhancement unit 713 is configured to:
determine a parameter corresponding to the minimum side length of the current block as the first parameter.

In some embodiments, the enhancement unit 713 is configured to:
perform feature extraction on the reference region to obtain first feature information;
perform multi-scale feature extraction on the first feature information and perform concatenation on the extracted multi-scale feature information to obtain second feature information;
determine third feature information based on the second feature information and feature information obtained by performing feature extraction on the second feature information;
perform multi-scale feature extraction on the third feature information and perform concatenation on the extracted multi-scale feature information to obtain fourth feature information; and
convert the fourth feature information into feature information having a same number of channels as the reference region to obtain the residual picture.

In some embodiments, the enhancement unit 713 is configured to:
perform quality enhancement on the reference region by using a dense-residual variable-size convolutional neural network (Dense-RVCNN) to obtain the enhancement picture.

In some embodiments, the enhancement unit 713 is configured to:
determine a network parameter used by the Dense-RVCNN based on a size of the current block; and
determine the enhancement picture based on the network parameter used by the Dense-RVCNN.

In some embodiments, the enhancement unit 713 is configured to:
determine a parameter corresponding to the minimum side length of the current block as the network parameter used by the Dense-RVCNN.

In some embodiments, the Dense-RVCNN includes at least one of the following:
an input layer configured to perform feature extraction on the reference region;
at least one residual variable-size convolutional block (RVCB) structure configured to perform multi-scale feature extraction and feature concatenation on feature information input into the at least one RVCB structure;
a dense network (DenseNet) structure configured to perform feature extraction on feature information input into the DenseNet structure; and
an output layer configured to convert an input feature information into feature information having a same number of channels as the reference region and to weight the reference region and the converted feature information.

In some embodiments, the at least one RVCB structure includes a plurality of RVCB structures; the input layer is connected to an input end of the DenseNet structure through a part of the plurality of RVCB structures, and an output end of the DenseNet structure is connected to the output layer through another part of the plurality of RVCB structures.

In some embodiments, the RVCB structure includes:
a plurality of first feature extraction layers connected in parallel, where the first feature extraction layer includes a convolutional layer, convolution kernels of convolutional layers in different first feature extraction layers of the plurality of first feature extraction layers are different, and a number of channels of the convolutional layer in the first feature extraction layer is a ratio of a number of channels of feature information input for the first feature extraction layer to a number of the plurality of first feature extraction layers;
a first concatenation layer configured to perform feature concatenation on feature information output by the plurality of first feature extraction layers;
a first convolutional layer configured to perform feature extraction on feature information output by the first concatenation layer; and
a skip connection layer configured to weight the feature information input for the RVCB structure and feature information output by the first convolutional layer.

In some embodiments, the DenseNet structure includes:
a plurality of second feature extraction layers connected in series, the second feature extraction layer including a convolutional layer;
a plurality of second concatenation layers, where two adjacent second feature extraction layers in the plurality of second feature extraction layers are connected through the second concatenation layer, and any one of the plurality of second concatenation layers is configured to perform feature concatenation on the feature information input for the DenseNet structure and feature information output by a previous second feature extraction layer of the any one second concatenation layer; and
a second convolutional layer, where a last second feature extraction layer in the plurality of second feature extraction layers is connected to the second convolutional layer through a last second concatenation layer in the plurality of second concatenation layers, and the second convolutional layer is configured to convert feature information output by the last second concatenation layer into feature information having a same number of channels as the feature information input for the DenseNet structure.

In some embodiments, the motion parameter of the current block includes at least one of the following: a motion vector of the current block or an index of the reference picture.

FIG. 20 is a schematic block diagram of an encoder 720 provided in embodiments of the present disclosure.

As shown in FIG. 20, the encoder 720 may include:
a first determining unit 721 configured to perform motion estimation on a current block to obtain a reference block of the current block;
an enhancement unit 722 configured to perform quality enhancement on the reference block to obtain an enhancement block; and
a second determining unit 723 configured to determine a prediction block of the current block based on the enhancement block.

In some embodiments, the enhancement unit 722 is configured to:
perform quality enhancement on a reference region including the reference block in a reference picture to obtain an enhancement picture;
determine the enhancement block in the enhancement picture based on a position of the reference block in the reference region.

In some embodiments, the enhancement unit 722 is configured to:
determine a block in the enhancement picture that has a same position as the reference block in the reference region as the enhancement block.

In some embodiments, the second determining unit 723 is configured to:
perform boundary extension and interpolation filtering on the enhancement block to obtain the prediction block.

In some embodiments, the first determining unit 721 is configured to:
partition the current block into at least one sub-block;
perform motion estimation on the current block to determine a motion parameter of the current block;
determine a motion parameter of the at least one sub-block based on the motion parameter of the current block; and
determine at least one reference sub-block included in the reference block based on a motion parameter of the at least one sub-block.

The enhancement unit 722 is configured to:
determine a first region where the at least one reference sub-block is located based on a position of the at least one reference sub-block in the reference region;
perform boundary extension on the first region to obtain a second region; and
determine a block in the enhancement picture whose position corresponds to the second region as the enhancement block.

In some embodiments, the second determining unit 723 is configured to:
determine at least one sub-block in the enhancement block that have a same position as the at least one reference sub-block in the reference region as at least one enhancement sub-block included in the enhancement block; and
perform boundary extension and interpolation filtering on the at least one enhancement sub-block to obtain at least one prediction sub-block included in the prediction block.

In some embodiments, the first region is a minimum region including the at least one reference sub-block.

In some embodiments, the reference region is an entire region or a partial region of the reference picture.

In some embodiments, the partial region is a region where any one of the following is located: a picture block, a sub-picture, a rectangular region, or a slice.

In some embodiments, the enhancement unit 722 is configured to:
perform feature extraction on the reference region to obtain a residual picture; and
weight the reference region and the residual picture to obtain the enhancement picture.

In some embodiments, the enhancement unit 722 is configured to:
determine a first parameter for performing feature extraction on the reference region based on a size of the current block; and
perform feature extraction on the reference region based on the first parameter to obtain the residual picture.

In some embodiments, the enhancement unit 722 is configured to:
determine a parameter corresponding to a minimum side length of the current block as the first parameter.

In some embodiments, the enhancement unit 722 is configured to:
perform feature extraction on the reference region to obtain first feature information;
perform multi-scale feature extraction on the first feature information and perform concatenation on the extracted multi-scale feature information to obtain second feature information;
determine third feature information based on the second feature information and feature information obtained by performing feature extraction on the second feature information;
perform multi-scale feature extraction on the third feature information and perform concatenation on the extracted multi-scale feature information to obtain fourth feature information; and
convert the fourth feature information into feature information having a same number of channels as the reference region to obtain the residual picture.

In some embodiments, the enhancement unit 722 is configured to:
perform quality enhancement on the reference region by using a dense-residual variable-size convolutional neural network (Dense-RVCNN) to obtain the enhancement picture.

In some embodiments, the enhancement unit 722 is configured to:
determine a network parameter used by the Dense-RVCNN based on a size of the current block; and
determine the enhancement picture based on the network parameter used by the Dense-RVCNN.

In some embodiments, the enhancement unit 722 is configured to:
determine a parameter corresponding to the minimum side length of the current block as the network parameter used by the Dense-RVCNN.

In some embodiments, the Dense-RVCNN includes at least one of the following:
an input layer configured to perform feature extraction on the reference region;
at least one residual variable-size convolutional block (RVCB) structure configured to perform multi-scale feature extraction and feature concatenation on feature information input into the at least one RVCB structure;
a dense network (DenseNet) structure configured to perform feature extraction on feature information input into the DenseNet structure; and
an output layer configured to convert an input feature information into feature information having a same number of channels as the reference region and to weight the reference region and the converted feature information.

In some embodiments, the at least one RVCB structure includes a plurality of RVCB structures; the input layer is connected to an input end of the DenseNet structure through a part of the plurality of RVCB structures, and an output end of the DenseNet structure is connected to the output layer through another part of the plurality of RVCB structures.

In some embodiments, the RVCB structure includes:
a plurality of first feature extraction layers connected in parallel, where the first feature extraction layer includes a convolutional layer, convolution kernels of convolutional layers in different first feature extraction layers of the plurality of first feature extraction layers are different, and a number of channels of the convolutional layer in the first feature extraction layer is a ratio of a number of channels of feature information input for the first feature extraction layer to a number of the plurality of first feature extraction layers;
a first concatenation layer configured to perform feature concatenation on feature information output by the plurality of first feature extraction layers;
a first convolutional layer configured to perform feature extraction on feature information output by the first concatenation layer; and
a skip connection layer configured to weight the feature information input for the RVCB structure and feature information output by the first convolutional layer.

In some embodiments, the DenseNet structure includes:
a plurality of second feature extraction layers connected in series, the second feature extraction layer including a convolutional layer;
a plurality of second concatenation layers, where two adjacent second feature extraction layers in the plurality of second feature extraction layers are connected through the second concatenation layer, and any one of the plurality of second concatenation layers is configured to perform feature concatenation on the feature information input for the DenseNet structure and feature information output by a previous second feature extraction layer of the any one second concatenation layer; and
a second convolutional layer, where a last second feature extraction layer in the plurality of second feature extraction layers is connected to the second convolutional layer through a last second concatenation layer in the plurality of second concatenation layers, and the second convolutional layer is configured to convert feature information output by the last second concatenation layer into feature information having a same number of channels as the feature information input for the DenseNet structure.

In some embodiments, the second determining unit 723 is further configured to:
encode a motion parameter of the current block;
where the motion parameter of the current block includes at least one of the following: a motion vector of the current block or an index of the reference picture.

FIG. 21 is a schematic block diagram of a neural network training apparatus 730 provided in embodiments of the present disclosure.

As shown in FIG. 21, the neural network training apparatus 730 may include:
an encoding unit 731 configured to encode a sample video to obtain a bitstream;
a decoding unit 732 configured to decode the bitstream to determine a prediction block of the current block; and
a training unit 733 configured to train a neural network based on a label of the current block and the prediction block.

In some embodiments, the decoding unit 732 is configured to:
determine prediction blocks of multiple sizes.

Training the neural network based on the label of the current block and the prediction block includes:
training the neural network based on the label of the current block and the prediction blocks of multiple sizes to obtain network parameters corresponding to the multiple sizes.

In some embodiments, the prediction blocks of multiple sizes include multiple prediction blocks with different minimum side lengths.

It should be understood that, the apparatus embodiments and the method embodiments may correspond to each other, and for similar descriptions, reference may be made to that of the method embodiments, which will not be repeated here to avoid repetition. In some implementations, the decoder 710 shown in FIG. 19 can correspond to the corresponding subject for performing the method 400 in the embodiments of the present disclosure, and the above and other operations and/or functions of various units in the decoder 710 are for implementing the corresponding processes in each method such as the method 400. Similarly, the encoder 720 shown in FIG. 20 can correspond to the corresponding subject for performing the method 500 in the embodiments of the present disclosure. That is, the above and other operations and/or functions of various units in the encoder 720 are for implementing the corresponding processes in each method such as the method 500. The neural network training apparatus 730 shown in FIG. 21 can correspond to the corresponding subject for performing the method 600 in the embodiments of the present disclosure. That is, the above and other operations and/or functions of various units in the neural network training apparatus 730 are for implementing the corresponding processes in each method such as the method 600.

It should also be understood that, the various units in the decoder 710, encoder 720 or neural network training apparatus 730 involved in the embodiments of the present disclosure may be individually or completely merged into one or several other units, or one (or some) of the various units may be further divided into multiple smaller units in function, which may achieve the same operation without affecting the realization of the technical effects of the embodiments of the present disclosure. The units mentioned above are divided based on logical functions. In actual applications, the functions of a single unit may be implemented by multiple units, or the functions of multiple units may be implemented by one unit. In some other embodiments of the present disclosure, the decoder 710, encoder 720 or neural network training apparatus 730 may also include other units, and in actual applications, these functions may also be implemented with the assistance of other units, and may be implemented by collaboration of multiple units. According to another embodiment of the present disclosure, by running a computer program (including program codes) capable of executing the steps involved in the corresponding method on a general-purpose computing device of a general-purpose computer including a processing element (e.g., a central processing unit (CPU)) and a storage element (e.g., a random access memory (RAM), or a read-only memory (ROM)), the decoder 710, encoder 720 or neural network training apparatus 730 involved in the embodiments of the present disclosure may be constructed, and the encoding method or decoding method in the embodiments of the present disclosure may be implemented. The computer program may be recorded on, for example, a non-transitory computer-readable storage medium, loaded into an electronic device via the non-transitory computer-readable storage medium, and run therein to implement the corresponding method in the embodiments of the present disclosure.

In other words, the units mentioned above may be implemented in the form of hardware, or implemented by in the form of software instructions, or implemented in the form of a combination of software and hardware. Specifically, the steps of the method embodiments in the embodiments of the present disclosure may be completed by the hardware integrated logic circuit and/or software instructions in the processor. The steps of the method disclosed in the embodiments of the present disclosure may be directly reflected as being executed by a hardware decoding processor, or being executed by a combination of hardware and software in the decoding processor. Alternatively, the software may be located in a mature storage medium in the art, such as a random access memory, a flash memory, a read-only memory, a programmable read-only memory, an electrically erasable programmable memory, or a register. The storage medium is located in the memory, and the processor reads the information in the memory and completes the steps in the above method embodiments in combination with the hardware.

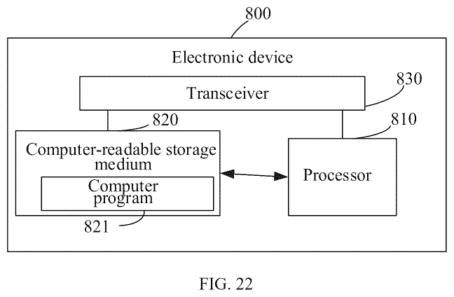

FIG. 22 is a schematic structural diagram of an electronic device 800 provided in embodiments of the present disclosure.

As shown in FIG. 22, the electronic device 800 includes at least a processor 810 and a non-transitory computer-readable storage medium 820. The processor 810 and the non-transitory computer-readable storage medium 820 may be connected via a bus or any other manner. The non-transitory computer-readable storage medium 820 is configured to store a computer program 821. The computer program 821 includes computer instructions. The processor 810 is configured to execute the computer instructions stored in the non-transitory computer-readable storage medium 820. The processor 810 is a computing core and control core of the electronic device 800, which is suitable for implementing one or more computer instructions, and is specifically suitable for loading and executing one or more computer instructions to implement corresponding method processes or corresponding functions.

The processor 810 may also be referred to as a central processing unit (CPU). The processor 810 may include, but is not limited to, a general-purpose processor, a digital signal processor (DSP), an application-specific integrated circuit (ASIC), a field programmable gate array (FPGA) or any other programmable logic device, a transistor logic device, or a discrete hardware component.

The non-transitory computer-readable storage medium 820 includes, but is not limited to, a volatile memory and/or a non-volatile memory.

The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which acts as external cache memory. For example, RAM includes, but is not limited to, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synch link dynamic random access memory (SLDRAM), or a direct rambus random access memory (DR RAM).

For example, the electronic device 800 may be an encoder or encoding framework involved in the embodiments of the present disclosure. A first computer instruction is stored in the (non-transitory) computer-readable storage medium 820, and the processor 810 loads and executes the first computer instruction stored in the computer-readable storage medium 820 to implement the corresponding steps in the encoding method provided in the embodiments of the present disclosure. In other words, the first computer instruction in the computer-readable storage medium 820 is loaded by the processor 810 to perform the corresponding steps, which is not repeated here to avoid repetition.

For example, the electronic device 800 may be a decoder or decoding framework involved in the embodiments of the present disclosure. A second computer instruction is stored in the computer-readable storage medium 820, and the processor 810 loads and executes the second computer instruction stored in the computer-readable storage medium 820 to implement the corresponding steps in the decoding method provided in the embodiments of the present disclosure. In other words, the second computer instruction in the computer-readable storage medium 820 is loaded by the processor 810 to perform the corresponding step, which is not repeated here to avoid repetition.

For example, the electronic device 800 may be the training apparatus involved in the embodiments of the present disclosure. A third computer instruction is stored in the computer-readable storage medium 820, and the processor 810 loads and executes the third computer instruction stored in the computer-readable storage medium 820 to implement the corresponding steps in the training method provided in the embodiments of the present disclosure. In other words, the third computer instruction in the computer-readable storage medium 820 is loaded by the processor 810 to perform the corresponding steps, which will not be repeated here to avoid repetition.

According to another aspect of the present disclosure, the present disclosure further provides a coding and decoding system, including the encoder and decoder mentioned above.

According to yet another aspect of the present disclosure, the present disclosure further provides a non-transitory computer-readable storage medium (memory), and non-transitory the computer-readable storage medium is a memory device in the electronic device 800 and is configured to store programs and data. For example, the non-transitory computer-readable storage medium is the computer readable storage medium 820. It can be understood that the computer-readable storage medium 820 herein may include both a built-in storage medium in the electronic device 800 and an extended storage medium supported by the electronic device 800. The non-transitory computer-readable storage medium provides a storage space, and an operating system of the electronic device 800 is stored in the storage space. In addition, the storage space also stores one or more computer instructions (e.g., at least one of the first computer instruction, second computer instruction, and third computer instruction mentioned above) suitable for being loaded and executed by the processor 810. The computer instruction(s) may be one or more computer programs 821 (including program codes).

According to yet another aspect of the present disclosure, the present disclosure further provides a computer program product or a computer program; the computer program product or the computer program includes a computer instruction (e.g., any one of the first computer instruction, second computer instruction, and third computer instruction mentioned above), and the computer instruction (e.g., the computer program 821) is stored in the non-transitory computer-readable storage medium. In this case, the electronic device 800 may be a computer; the processor 810 reads the computer instruction from the computer-readable storage medium 820, and the processor 810 executes the computer instruction to enable the computer to perform the methods provided in the various optional implementations mentioned above.

That is to say, when implemented by using software, the methods provided in the various optional implementations mentioned above may be implemented in whole or in part in the form of a computer program product. The computer program product includes one or more computer instructions. When the computer program instruction(s) are loaded and executed on a computer, the processes in the embodiments of the present disclosure are run in whole or in part or the functions of the embodiments of the present disclosure are achieved. The computer may be a general-purpose computer, a special-purpose computer, a computer network, or any other programmable device. The computer instruction may be stored in the non-transitory computer-readable storage medium or transmitted from a non-transitory computer-readable storage medium to another non-transitory computer-readable storage medium. For example, the computer instruction may be transmitted from a website, computer, server, or data center to another website, computer, server, or data center through a wired manner (e.g., coaxial cable, optical fiber, digital subscriber line (DSL)) or a wireless manner (e.g., infrared, wireless, or microwave).

Those skilled in the art will appreciate that the units and process steps of each example described in combination with the embodiments disclosed herein can be implemented by electronic hardware, or a combination of computer software and electronic hardware. Whether these functions are performed in hardware or software depends on the specific application and design constraints of the technical solution. Those skilled in the art can use different methods to implement the described functions for each specific application, but such implementation should not be considered to be beyond the scope of the present disclosure.

Finally, it should be noted that the above content is only a specific implementation of the present disclosure, but the protection scope of the present disclosure is not limited thereto. Any person skilled in the art may readily conceive of variations or substitutions within the technical scope disclosed in the present disclosure, which should be included within the protection scope of the present disclosure. Therefore, the protection scope of the present disclosure shall be subject to the protection scope of the claims.

In a first clause, a decoding method is provided, which includes:
decoding a bitstream to determine a motion parameter of a current block;
determining a reference block of the current block in a reference picture of the current block based on the motion parameter of the current block;
performing quality enhancement on the reference block to obtain an enhancement block; and
determining a prediction block of the current block based on the enhancement block.

In a second clause, according to the first clause, where performing quality enhancement on the reference block to obtain the enhancement block, includes:
performing quality enhancement on a reference region including the reference block in the reference picture to obtain an enhancement picture; and
determining the enhancement block in the enhancement picture based on a position of the reference block in the reference region.

In a third clause, according to the second clause, where determining the enhancement block in the enhancement picture based on the position of the reference block in the reference region, includes:
determining a block in the enhancement picture that has a same position as the reference block in the reference region as the enhancement block.

In a fourth clause, according to the third clause, where determining the prediction block of the current block based on the enhancement block, includes:
performing boundary extension and interpolation filtering on the enhancement block to obtain the prediction block.

In a fifth clause, according to the second clause, where determining the reference block of the current block in the reference picture of the current block based on the motion parameter of the current block, includes:
partitioning the current block into at least one sub-block;
determining a motion parameter of the at least one sub-block based on the motion parameter of the current block; and
determining at least one reference sub-block included in the reference block based on the motion parameter of the at least one sub-block;
where determining the enhancement block in the enhancement picture based on the position of the reference block in the reference region, includes:
determining a first region where the at least one reference sub-block is located based on a position of the at least one reference sub-block in the reference region;
performing boundary extension on the first region to obtain a second region; and
determining a block in the enhancement picture whose position corresponds to the second region as the enhancement block.

In a sixth clause, according to the fifth clause, where determining the prediction block of the current block based on the enhancement block, includes:
determining at least one sub-block in the enhancement block that have a same position as the at least one reference sub-block in the reference region as at least one enhancement sub-block included in the enhancement block; and
performing boundary extension and interpolation filtering on the at least one enhancement sub-block to obtain at least one prediction sub-block included in the prediction block.

In a seventh clause, according to the fifth clause, where the first region is a minimum region including the at least one reference sub-block.

In an eighth clause, according to any one of the second clause to the seventh clause, where the reference region is an entire region or a partial region of the reference picture.

In a ninth clause, according to the eighth clause, where the partial region is a region where any one of the following is located: a picture block, a sub-picture, a rectangular region, or a slice.

In a tenth clause, according to any one of the second clause to the ninth clause, where performing quality enhancement on the reference region including the reference block in the reference picture to obtain the enhancement picture, includes:
performing feature extraction on the reference region to obtain a residual picture; and
weighting the reference region and the residual picture to obtain the enhancement picture.

In an eleventh clause, according to the tenth clause, where performing feature extraction on the reference region to obtain the residual picture, includes:
determining a first parameter for performing feature extraction on the reference region based on a size of the current block; and
performing feature extraction on the reference region based on the first parameter to obtain the residual picture.

In a twelfth clause, according to the eleventh clause, where determining the first parameter for performing feature extraction on the reference region based on the size of the current block, includes:
determining a parameter corresponding to a minimum side length of the current block as the first parameter.

In a thirteenth clause, according to any one of the tenth clause to the twelfth clause, where performing feature extraction on the reference region to obtain the residual picture, includes:
performing feature extraction on the reference region to obtain first feature information;
performing multi-scale feature extraction on the first feature information and performing concatenation on the extracted multi-scale feature information to obtain second feature information;
determining third feature information based on the second feature information and feature information obtained by performing feature extraction on the second feature information;
performing multi-scale feature extraction on the third feature information and performing concatenation on the extracted multi-scale feature information to obtain fourth feature information; and
converting the fourth feature information into feature information having a same number of channels as the reference region to obtain the residual picture.

In a fourteenth clause, according to any one of the second clause to the ninth clause, where performing quality enhancement on the reference region including the reference block in the reference picture to obtain the enhancement picture, includes:
performing quality enhancement on the reference region by using a dense-residual variable-size convolutional neural network (Dense-RVCNN) to obtain the enhancement picture.

In a fifteenth clause, according to the fourteenth clause, where performing quality enhancement on the reference region by using the dense-residual variable-size convolutional neural network (Dense-RVCNN) to obtain the enhancement picture, includes:
determining a network parameter used by the Dense-RVCNN based on a size of the current block; and
determining the enhancement picture based on the network parameter used by the Dense-RVCNN.

In a sixteenth clause, according to the fifteenth clause, where determining the network parameter used by the Dense-RVCNN based on the size of the current block, includes:
determining a parameter corresponding to a minimum side length of the current block as the network parameter used by the Dense-RVCNN.

In a seventeenth clause, according to any one of the fourteenth clause to the sixteenth clause, where the Dense-RVCNN includes at least one of the following:
an input layer configured to perform feature extraction on the reference region;
at least one residual variable-size convolutional block (RVCB) structure configured to perform multi-scale feature extraction and feature concatenation on feature information input into the at least one RVCB structure;
a dense network (DenseNet) structure configured to perform feature extraction on feature information input into the DenseNet structure; and
an output layer configured to convert an input feature information into feature information having a same number of channels as the reference region and to weight the reference region and the converted feature information.

In an eighteenth clause, according to the seventeenth clause, where the at least one RVCB structure includes a plurality of RVCB structures; the input layer is connected to an input end of the DenseNet structure through a part of the plurality of RVCB structures, and an output end of the DenseNet structure is connected to the output layer through another part of the plurality of RVCB structures.

In a nineteenth clause, according to the seventeenth clause, where a RVCB structure includes:
a plurality of first feature extraction layers connected in parallel, where a first feature extraction layer includes a convolutional layer, convolution kernels of convolutional layers in different first feature extraction layers of the plurality of first feature extraction layers are different, and a number of channels of the convolutional layer in the first feature extraction layer is a ratio of a number of channels of feature information input for the first feature extraction layer to a number of the plurality of first feature extraction layers;
a first concatenation layer configured to perform feature concatenation on feature information output by the plurality of first feature extraction layers;
a first convolutional layer configured to perform feature extraction on feature information output by the first concatenation layer; and
a skip connection layer configured to weight the feature information input for the RVCB structure and feature information output by the first convolutional layer.

In a twentieth clause, according to the seventeenth clause, where the DenseNet structure includes:
a plurality of second feature extraction layers connected in series, where a second feature extraction layer includes a convolutional layer;
a plurality of second concatenation layers, where two adjacent second feature extraction layers in the plurality of second feature extraction layers are connected through a second concatenation layer, and any one of the plurality of second concatenation layers is configured to perform feature concatenation on the feature information input for the DenseNet structure and feature information output by a previous second feature extraction layer of the any one second concatenation layer; and
a second convolutional layer, where a last second feature extraction layer in the plurality of second feature extraction layers is connected to the second convolutional layer through a last second concatenation layer in the plurality of second concatenation layers, and the second convolutional layer is configured to convert feature information output by the last second concatenation layer into feature information having a same number of channels as the feature information input for the DenseNet structure.

In a twenty-first clause, according to any one of the first clause to the twentieth clause, where the motion parameter of the current block includes at least one of the following: a motion vector of the current block or an index of the reference picture.

In a twenty-second clause, an encoding method is provided, which includes:
performing motion estimation on a current block to obtain a reference block of the current block;
performing quality enhancement on the reference block to obtain an enhancement block; and
   determining a prediction block of the current block based on the enhancement block.

In a twenty-third clause, according to the twenty-second clause, where performing quality enhancement on the reference block to obtain the enhancement block, includes:
performing quality enhancement on a reference region including the reference block in a reference picture to obtain an enhancement picture; and
determining the enhancement block in the enhancement picture based on a position of the reference block in the reference region.

In a twenty-fourth clause, according to the twenty-third clause, where determining the enhancement block in the enhancement picture based on the position of the reference block in the reference region, includes:
determining a block in the enhancement picture that has a same position as the reference block in the reference region as the enhancement block.

In a twenty-fifth clause, according to the twenty-fourth clause, where determining the prediction block of the current block based on the enhancement block, includes:
performing boundary extension and interpolation filtering on the enhancement block to obtain the prediction block.

In a twenty-sixth clause, according to the twenty-third clause, where performing motion estimation on the current block to obtain the reference block of the current block, includes:
partitioning the current block into at least one sub-block;
performing motion estimation on the current block to determine a motion parameter of the current block;
determining a motion parameter of the at least one sub-block based on the motion parameter of the current block; and
determining at least one reference sub-block included in the reference block based on the motion parameter of the at least one sub-block;
where determining the enhancement block in the enhancement picture based on the position of the reference block in the reference region, includes:
determining a first region where the at least one reference sub-block is located based on a position of the at least one reference sub-block in the reference region;
performing boundary extension on the first region to obtain a second region; and
determining a block in the enhancement picture whose position corresponds to the second region as the enhancement block.

In a twenty-seventh clause, according to the twenty-sixth clause, where determining the prediction block of the current block based on the enhancement block, includes:
determining at least one sub-block in the enhancement block that have a same position as the at least one reference sub-block in the reference region as at least one enhancement sub-block included in the enhancement block; and
performing boundary extension and interpolation filtering on the at least one enhancement sub-block to obtain at least one prediction sub-block included in the prediction block.

In a twenty-eighth clause, according to the twenty-sixth clause, where the first region is a minimum region including the at least one reference sub-block.

In a twenty-ninth clause, according to any one of the twenty-third clause to the twenty-eighth clause, where the reference region is an entire region or a partial region of the reference picture.

In a thirtieth clause, according to the twenty-ninth clause, where the partial region is a region where any one of the following is located: a picture block, a sub-picture, a rectangular region, or a slice.

In a thirty-first clause, according to any one of the twenty-third clause to the thirtieth clause, where performing quality enhancement on the reference region including the reference block in the reference picture to obtain the enhancement picture, includes:
performing feature extraction on the reference region to obtain a residual picture; and
weighting the reference region and the residual picture to obtain the enhancement picture.

In a thirty-second clause, according to the thirty-first clause, where performing feature extraction on the reference region to obtain the residual picture, includes:
determining a first parameter for performing feature extraction on the reference region based on a size of the current block; and
performing feature extraction on the reference region based on the first parameter to obtain the residual picture.

In a thirty-third clause, according to the thirty-second clause, where determining the first parameter for performing feature extraction on the reference region based on the size of the current block, includes:
determining a parameter corresponding to a minimum side length of the current block as the first parameter.

In a thirty-fourth clause, according to any one of the thirty-first clause to the thirty-third clause, where performing feature extraction on the reference region to obtain the residual picture, includes:
performing feature extraction on the reference region to obtain first feature information;
performing multi-scale feature extraction on the first feature information and performing concatenation on the extracted multi-scale feature information to obtain second feature information;
determining third feature information based on the second feature information and feature information obtained by performing feature extraction on the second feature information;
performing multi-scale feature extraction on the third feature information and performing concatenation on the extracted multi-scale feature information to obtain fourth feature information; and
converting the fourth feature information into feature information having a same number of channels as the reference region to obtain the residual picture.

In a thirty-fifth clause, according to any one of the twenty-third clause to the thirtieth clause, where performing quality enhancement on the reference region including the reference block in the reference picture to obtain the enhancement picture, includes:
performing quality enhancement on the reference region by using a dense-residual variable-size convolutional neural network (Dense-RVCNN) to obtain the enhancement picture.

In a thirty-sixth clause, according to the thirty-fifth clause, where performing quality enhancement on the reference region by using the dense-residual variable-size convolutional neural network (Dense-RVCNN) to obtain the enhancement picture, includes:
determining a network parameter used by the Dense-RVCNN based on a size of the current block; and
determining the enhancement picture based on the network parameter used by the Dense-RVCNN.

In a thirty-seventh clause, according to the thirty-sixth clause, where determining the network parameter used by the Dense-RVCNN based on the size of the current block, includes:
determining a parameter corresponding to a minimum side length of the current block as the network parameter used by the Dense-RVCNN.

In a thirty-eighth clause, according to any one of the thirty-fifth clause to the thirty-seventh clause, where the Dense-RVCNN includes at least one of the following:
an input layer configured to perform feature extraction on the reference region;
at least one residual variable-size convolutional block (RVCB) structure configured to perform multi-scale feature extraction and feature concatenation on feature information input into the at least one RVCB structure;
a dense network (DenseNet) structure configured to perform feature extraction on feature information input into the DenseNet structure; and
an output layer configured to convert an input feature information into feature information having a same number of channels as the reference region and to weight the reference region and the converted feature information.

In a thirty-ninth clause, according to the thirty-eighth clause, where the at least one RVCB structure includes a plurality of RVCB structures; the input layer is connected to an input end of the DenseNet structure through a part of the plurality of RVCB structures, and an output end of the DenseNet structure is connected to the output layer through another part of the plurality of RVCB structures.

In a fortieth clause, according to the thirty-eighth clause, where a RVCB structure includes:
a plurality of first feature extraction layers connected in parallel, where a first feature extraction layer includes a convolutional layer, convolution kernels of convolutional layers in different first feature extraction layers of the plurality of first feature extraction layers are different, and a number of channels of the convolutional layer in the first feature extraction layer is a ratio of a number of channels of feature information input for the first feature extraction layer to a number of the plurality of first feature extraction layers;
a first concatenation layer configured to perform feature concatenation on feature information output by the plurality of first feature extraction layers;
a first convolutional layer configured to perform feature extraction on feature information output by the first concatenation layer; and
a skip connection layer configured to weight the feature information input for the RVCB structure and feature information output by the first convolutional layer.

In a forty-first clause, according to the thirty-eighth clause, where the DenseNet structure includes:
a plurality of second feature extraction layers connected in series, where a second feature extraction layer includes a convolutional layer;
a plurality of second concatenation layers, where two adjacent second feature extraction layers in the plurality of second feature extraction layers are connected through a second concatenation layer, and any one of the plurality of second concatenation layers is configured to perform feature concatenation on the feature information input for the DenseNet structure and feature information output by a previous second feature extraction layer of the any one second concatenation layer; and
a second convolutional layer, where a last second feature extraction layer in the plurality of second feature extraction layers is connected to the second convolutional layer through a last second concatenation layer in the plurality of second concatenation layers, and the second convolutional layer is configured to convert feature information output by the last second concatenation layer into feature information having a same number of channels as the feature information input for the DenseNet structure.

In a forty-second clause, according to any one of the twenty-second clause to the forty-first clause, further including:
encoding a motion parameter of the current block;
where the motion parameter of the current block includes at least one of the following: a motion vector of the current block or an index of the reference picture.

In a forty-third clause, a neural network training method is provided, which includes:
encoding a sample video to obtain a bitstream;
decoding the bitstream to determine a prediction block of a current block; and
training a neural network based on a label of the current block and the prediction block.

In a forty-fourth clause, according to the forty-third clause, where decoding the bitstream to determine the prediction block of the current block, includes:
determining prediction blocks of multiple sizes;
where training the neural network based on the label of the current block and the prediction block, includes:
training the neural network based on the label of the current block and the prediction blocks of multiple sizes to obtain network parameters corresponding to the multiple sizes.

In a forty-fifth clause, according to the forty-fourth clause, where the prediction blocks of multiple sizes include multiple prediction blocks with different minimum side lengths.

What is claimed is:

1. A decoding method, comprising:
decoding a bitstream to determine a motion parameter of a current block;
determining a reference block of the current block in a reference picture of the current block based on the motion parameter of the current block;
performing quality enhancement on the reference block to obtain an enhancement block; and
determining a prediction block of the current block based on the enhancement block.

2. The method according to claim 1, wherein performing quality enhancement on the reference block to obtain the enhancement block, comprises:
performing quality enhancement on a reference region comprising the reference block in the reference picture to obtain an enhancement picture; and
determining the enhancement block in the enhancement picture based on a position of the reference block in the reference region.

3. The method according to claim 2, wherein determining the enhancement block in the enhancement picture based on the position of the reference block in the reference region, comprises:
determining a block in the enhancement picture that has a same position as the reference block in the reference region as the enhancement block.

4. The method according to claim 3, wherein determining the prediction block of the current block based on the enhancement block, comprises:
performing boundary extension and interpolation filtering on the enhancement block to obtain the prediction block.

5. The method according to claim 2, wherein determining the reference block of the current block in the reference picture of the current block based on the motion parameter of the current block, comprises:
partitioning the current block into at least one sub-block;
determining a motion parameter of the at least one sub-block based on the motion parameter of the current block; and
determining at least one reference sub-block comprised in the reference block based on the motion parameter of the at least one sub-block;
wherein determining the enhancement block in the enhancement picture based on the position of the reference block in the reference region, comprises:
determining a first region where the at least one reference sub-block is located based on a position of the at least one reference sub-block in the reference region;
performing boundary extension on the first region to obtain a second region; and
determining a block in the enhancement picture whose position corresponds to the second region as the enhancement block.

6. The method according to claim 5, wherein determining the prediction block of the current block based on the enhancement block, comprises:
determining at least one sub-block in the enhancement block that have a same position as the at least one reference sub-block in the reference region as at least one enhancement sub-block comprised in the enhancement block; and
performing boundary extension and interpolation filtering on the at least one enhancement sub-block to obtain at least one prediction sub-block comprised in the prediction block.

7. The method according to claim 5, wherein the first region is a minimum region comprising the at least one reference sub-block.

8. The method according to claim 2, wherein the reference region is an entire region or a partial region of the reference picture.

9. The method according to claim 8, wherein the partial region is a region where any one of the following is located: a picture block, a sub-picture, a rectangular region, or a slice.

10. The method according to claim 2, wherein performing quality enhancement on the reference region comprising the reference block in the reference picture to obtain the enhancement picture, comprises:
performing feature extraction on the reference region to obtain a residual picture; and
weighting the reference region and the residual picture to obtain the enhancement picture.

11. The method according to claim 10, wherein performing feature extraction on the reference region to obtain the residual picture, comprises:
determining a first parameter for performing feature extraction on the reference region based on a size of the current block; and
performing feature extraction on the reference region based on the first parameter to obtain the residual picture.

12. The method according to claim 11, wherein determining the first parameter for performing feature extraction on the reference region based on the size of the current block, comprises:
determining a parameter corresponding to a minimum side length of the current block as the first parameter.

13. The method according to claim 10, wherein performing feature extraction on the reference region to obtain the residual picture, comprises:
performing feature extraction on the reference region to obtain first feature information;
performing multi-scale feature extraction on the first feature information and performing concatenation on extracted multi-scale feature information to obtain second feature information;
determining third feature information based on the second feature information and feature information obtained by performing feature extraction on the second feature information;
performing multi-scale feature extraction on the third feature information and performing concatenation on the extracted multi-scale feature information to obtain fourth feature information; and
converting the fourth feature information into feature information having a same number of channels as the reference region to obtain the residual picture.

14. The method according to claim 2, wherein performing quality enhancement on the reference region comprising the reference block in the reference picture to obtain the enhancement picture, comprises:
performing quality enhancement on the reference region by using a dense-residual variable-size convolutional neural network (Dense-RVCNN) to obtain the enhancement picture.

15. The method according to claim 14, wherein performing quality enhancement on the reference region by using the dense-residual variable-size convolutional neural network (Dense-RVCNN) to obtain the enhancement picture, comprises:
determining a network parameter used by the Dense-RVCNN based on a size of the current block; and
determining the enhancement picture based on the network parameter used by the Dense-RVCNN.

16. The method according to claim 15, wherein determining the network parameter used by the Dense-RVCNN based on the size of the current block, comprises:
determining a parameter corresponding to a minimum side length of the current block as the network parameter used by the Dense-RVCNN.

17. The method according to claim 14, wherein the Dense-RVCNN comprises at least one of the following:
an input layer configured to perform feature extraction on the reference region;
at least one residual variable-size convolutional block (RVCB) structure configured to perform multi-scale feature extraction and feature concatenation on feature information input into the at least one RVCB structure;
a dense network (DenseNet) structure configured to perform feature extraction on feature information input into the DenseNet structure; and
an output layer configured to convert an input feature information into feature information having a same number of channels as the reference region and to weight the reference region and the converted feature information.

18. The method according to claim 1, wherein the motion parameter of the current block comprises at least one of the following: a motion vector of the current block or an index of the reference picture.

19. An encoding method, comprising:
performing motion estimation on a current block to obtain a reference block of the current block;
performing quality enhancement on the reference block to obtain an enhancement block; and
determining a prediction block of the current block based on the enhancement block.

20. A decoder, comprising:
a processor adapted to execute computer programs; and
a computer-readable storage medium having stored a computer program therein, wherein the computer program, when executed by the processor, performs the following operations:
decoding a bitstream to determine a motion parameter of a current block;
determining a reference block of the current block in a reference picture of the current block based on the motion parameter of the current block;
performing quality enhancement on the reference block to obtain an enhancement block; and
determining a prediction block of the current block based on the enhancement block.
